(19) United States
(12) Patent Application Publication
(10) Pub. No.: US 2026/0014720 A1
(43) Pub. Date: Jan. 15, 2026

(54) RAZOR ASSEMBLY

(71) Applicant: DORCO CO., LTD., Seoul (KR)

(72) Inventors: Jun Soo CHANG, Seoul (KR); Sung Hee SON, Seoul (KR); Sang Hun PARK, Seoul (KR)

(21) Appl. No.: 19/337,017

(22) Filed: Sep. 23, 2025

Related U.S. Application Data
(63) Continuation of application No. PCT/KR2024/003990, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/52; B26B 21/22; B26B 21/40; B26B 21/44; B26B 21/48

(52) U.S. Cl. CPC B26B 21/521; B26B 21/225; B26B 21/4018; B26B 21/4025; B26B 21/4056; B26B 21/443; B26B 21/48

(57) ABSTRACT

A razor assembly may include at least one blade formed with a cutting edge. The razor assembly may also include a blade housing accommodating the at least one blade in a longitudinal direction, and a connector disposed on one side of the blade housing. The razor assembly may further include a razor handle connected to the blade housing so that the blade housing can pivot, the razor handle including a coupling portion configured to couple with the connector. The razor assembly may further include a restoring force providing portion configured to provide a restoring force against pivoting of the blade housing, the restoring force providing portion being configured to cover at least a portion of the coupling portion from above the coupling portion.

### CROSS REFERENCE TO RELATED APPLICATIONS

This is a continuation application of International Patent Application No. PCT/KR2024/003990 filed on Mar. 28, 2024, which claims priority to Korean patent application No. 10-2023-0040806 filed on Mar. 28, 2023, Korean patent application No. 10-2023-0068696 filed on May 26, 2023, and Korean patent application No. 10-2023-0095160 filed on Jul. 21, 2023, contents of each of which are incorporated herein by reference in their entireties.

### BACKGROUND

### Technical Field

The disclosure relates to a razor assembly, and more specifically to a razor assembly including a razor cartridge and a razor handle.

### Description of Related Technology

In general, a razor refers to a product for cutting body hair such as fuzz and beard on a face or body, and includes a razor handle for gripping, and a razor cartridge with a razor blade that comes into contact with skin to shave.

### SUMMARY

One aspect is a razor assembly, in which the exposure of a coupling portion provided in a razor handle to be coupled to a razor cartridge is minimized.

Another aspect is a razor assembly, in which a razor handle and a razor cartridge are easily and accurately coupled, and a user can easily recognize a coupling direction of the razor handle to the razor cartridge.

Another aspect is a razor assembly, in which a resting angle of a razor cartridge is lowered to improve shaving performance and shaving convenience.

Another aspect is a razor assembly, in which unintended detachment of a razor cartridge and a razor handle is minimized during a shaving process.

Another aspect is a razor assembly improved in convenient functions for shaving.

The aspects of the disclosure are not limited to those described herein, and other aspects not mentioned herein may become apparent to those skilled in the art from the following description.

Another aspect is a razor assembly including: at least one blade formed with a cutting edge; a blade housing accommodating the at least one blade in a longitudinal direction; a connector disposed on one side of the blade housing; a razor handle connected to the blade housing so that the blade housing can pivot, the razor handle including a coupling portion configured to couple with the connector; and a restoring force providing portion configured to provide a restoring force against pivoting of the blade housing, the restoring force providing portion being configured to cover at least a portion of the coupling portion from above the coupling portion.

Other details of the disclosure are included in the detailed description and the accompanying drawings.

According to the embodiments of the disclosure, the effects are at least as follows.

The coupling portion provided in the razor handle and coupled to the connector of the razor cartridge is not exposed to the outside.

Therefore, the coupling portion is protected from external impact, thereby extending the lifespan of the razor handle.

Further, the razor handle and the razor cartridge are easily and accurately coupled.

In addition, a user can easily recognize the coupling direction of the razor handle to the razor cartridge.

Further, the shaving performance and the shaving convenience are improved by a lower resting angle of the razor cartridge.

Further, the unintended detachment of the razor cartridge and the razor handle is minimized during the shaving process.

Further, the convenient functions for shaving are enhanced by the functional provider.

The effects of the disclosure are not limited to those described above, and various other effects are included in the foregoing description.

### BRIEF DESCRIPTION OF THE DRAWINGS

FIG. 1 is a perspective view of a razor assembly according to an embodiment of the disclosure.

FIG. 2 is a plane view of a razor cartridge according to an embodiment of the disclosure.

FIG. 3 is a bottom view of a razor cartridge according to an embodiment of the disclosure.

FIG. 4 is a perspective view showing the bottom of a razor cartridge according to an embodiment of the disclosure.

FIG. 5 is an exploded perspective view of a handle head according to an embodiment of the disclosure, viewed from above.

FIG. 6 is an exploded perspective view of a handle head according to an embodiment of the disclosure, viewed from below.

FIG. 7 is a view showing a position relationship among a first arm, a second arm and a pusher in a neutral state.

FIG. 8 is a view showing a position relationship among a first arm, a second arm and a pusher in a coupling process.

FIG. 9 is a view showing a position relationship among a first arm, a second arm and a pusher in a detachment process.

FIG. 10 is a plan view showing a state immediately before a handle head is coupled to a razor cartridge according to an embodiment of the disclosure.

FIG. 11 is a bottom view showing the handle head in the state of FIG. 10.

FIG. 12 is a plan view showing a state that a handle head is coupled to a razor cartridge according to an embodiment of the disclosure.

FIG. 13 is a bottom view showing the handle head in the state of FIG. 12.

FIG. 14 is a perspective view showing a portion of a razor assembly from which the plunger is omitted from the state of FIG. 12.

FIG. 15 is a perspective view showing a plunger according to a second embodiment of the disclosure.

FIG. 16 is a bottom view showing a handle head in a state that the handle head to which the plunger according to the second embodiment of the disclosure is applied is detached from a razor cartridge.

FIG. 17 is a bottom view showing a state that a handle head to which the plunger according to the second embodiment of the disclosure is applied is coupled to a razor cartridge.

FIG. 18 is a bottom view showing an alternative example of a razor cartridge according to an embodiment of the disclosure.

FIG. 19 is a view showing a portion of a handle head according to a third embodiment of the disclosure.

FIG. 20 is a schematic cross-sectional view of the handle head according to the third embodiment of the disclosure.

FIG. 21 is a view showing a portion of a handle head according to a fourth embodiment of the disclosure.

FIG. 22 is a bottom view showing a plunger according to the fourth embodiment of the disclosure.

FIG. 23 is a view showing a coupled state of a plunger lower housing and the plunger according to the fourth embodiment of the disclosure.

FIG. 24 is a schematic cross-sectional view of a handle head according to the fourth embodiment of the disclosure

FIG. 25 is a perspective view showing a coupling portion according to a fifth embodiment of the disclosure.

FIG. 26 is a lateral view showing the coupling portion according to the fifth embodiment of the disclosure.

FIG. 27 is a front view showing the coupling portion according to the fifth embodiment of the disclosure.

FIG. 28 is a view showing a coupled state of the coupling portion according to the fifth embodiment of the disclosure and a razor cartridge in a resting state.

FIG. 29 is a view showing a coupled state of the coupling portion according to the fifth embodiment of the disclosure and a razor cartridge in a maximum pivoted state.

FIG. 30 is a view showing a state in which a razor assembly according to an embodiment of the disclosure is put on a floor.

FIG. 31 is a lateral view showing a detached state of a razor handle including the coupling portion according to the fifth embodiment of the disclosure.

FIG. 32 is a plan view showing a detached state of a razor handle including the coupling portion according to the fifth embodiment of the disclosure.

FIG. 33 is a view showing a neutral state of the coupling portion according to the fifth embodiment of the disclosure.

FIG. 34 is a view showing a state of a coupling process according to the fifth embodiment of the disclosure.

FIG. 35 is a perspective view showing a coupling portion according to a sixth embodiment of the disclosure.

FIG. 36 is a bottom view showing a plunger portion according to the sixth embodiment of the disclosure.

FIGS. 37 and 38 are views for describing whether the plunger according to the sixth embodiment of the disclosure in a forward state interferes with the coupling portion according to the sixth embodiment of the disclosure.

FIG. 39 is a view for describing whether the plunger according to the sixth embodiment of the disclosure in a retreat state interferes with the coupling portion according to the sixth embodiment of the disclosure.

### DETAILED DESCRIPTION

To make the razor cartridge come into close contact with a user's skin along the curvy contours of the skin, the razor cartridge is pivotally coupled to the razor handle.

The razor handle is formed with a coupling portion for coupling with the razor cartridge, and the coupling portion generally has a structure in which the razor cartridge is pivotally coupled to the razor handle.

When the razor handle is detached from the razor cartridge, the coupling portion is exposed to the outside. If an external impact is applied to the coupling portion while the coupling portion is exposed to the outside, the coupling portion often becomes deformed or damaged, thereby making it difficult to normally couple with the razor cartridge.

In the process of coupling the razor handle and the razor cartridge, the coupling portion and the razor cartridge are often improperly coupled, or it is often inconvenient for a user to couple the razor handle and the razor cartridge due to poor recognition of a coupling direction of the coupling portion with respect to the razor cartridge.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, in describing components according to an embodiment of the disclosure, terms such as first, second, i), ii), a), and b) may be used. These terms are merely for distinguishing one component from other components, but not limit the substances, order, or sequence of the components. Throughout this specification, when a part “includes” or “comprises” a component, this means that the part further includes other components rather than excluding other components unless explicitly stated otherwise.

Below, a razor assembly according to embodiments of the disclosure will be described with reference to the accompanying drawings.

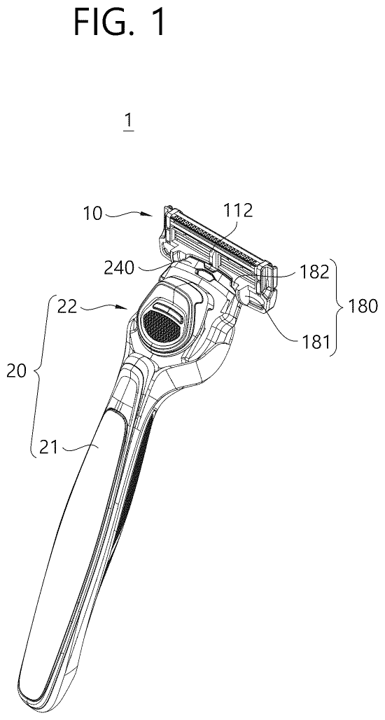

FIG. 1 is a perspective view of a razor assembly 1 according to an embodiment of the disclosure.

Referring to FIG. 1, the razor assembly 1 according to an embodiment includes a razor cartridge 10, and a razor handle 20 to which the razor cartridge 10 is pivotally coupled.

The razor handle 20 includes a handle body 21 and a handle head 22.

The handle body 21 refers to a portion to be gripped by a user.

The handle head 22 is provided at a first end of the handle body 21, is detachably coupled to the razor cartridge 10, and pivotally supports the coupled razor cartridge 10.

The handle head 22 may be detachably coupled to a connector 180 formed in the razor cartridge 10, and pivotably support the razor cartridge 10 within a predetermined angular range about a fixed axis or an axis moving within a predetermined range. For example, the razor cartridge 10 may be pivotably supported within an angular range less than or equal to 90 degrees, preferably less than or equal to 50 degrees, more preferably less than or equal to 45 degrees from a resting position (i.e., a position where the razor cartridge 10 receives no external force while being coupled to the razor handle 20) with respect to the razor handle 20. Regarding the handle head 22, details will be described later.

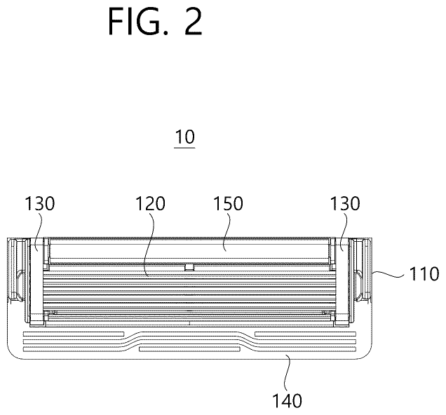

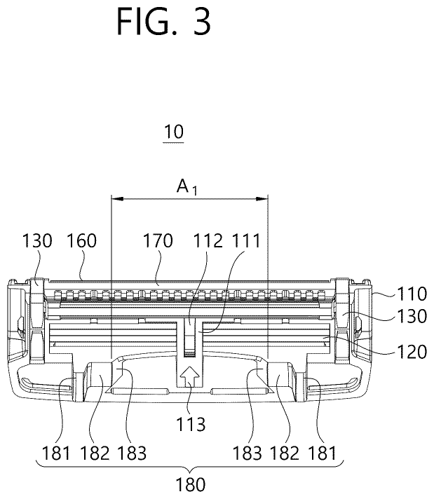

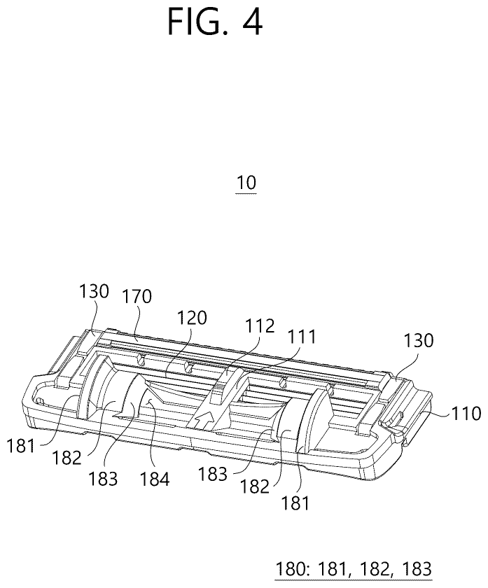

FIG. 2 is a plane view of the razor cartridge 10 according to an embodiment of the disclosure, FIG. 3 is a bottom view of the razor cartridge 10 according to an embodiment of the disclosure, and FIG. 4 is a perspective view showing the bottom of the razor cartridge 10 according to an embodiment of the disclosure.

Referring to FIG. 2, the razor cartridge 10 may include all or some of a blade housing 110, a plurality of blades 120, a clip 130, a guard 140, and a cap 150.

The blade housing 110 may accommodate each blade 120 in a longitudinal direction, and the blades 120 may be arranged in a row in a transverse direction. With respect to FIG. 2, the longitudinal direction refers to a horizontal direction, and the transverse direction refers to a vertical direction. FIG. 2 illustrates an example in which the razor cartridge 10 includes five blades 120, but the number of blades 120 may vary depending on embodiments.

The upper surface of the blade housing 110 to be described below refers to a surface that comes into contact with or faces a user's skin during a shaving process, and may be a surface toward which the cutting edge of each blade 120 faces. FIG. 2 illustrates the upper surface of the blade housing 110.

Further, the lower surface of the blade housing 110 refers to a surface located opposite the upper surface, and FIG. 3 illustrates the lower surface of the blade housing 110.

Further, the front of the blade housing 110 may be a direction (shaving direction) in which the blade housing 110 moves relative to a user's skin during the shaving process. For example, with reference to FIG. 2, the front of the blade housing 110 may refer to a direction from the blade 120 toward the guard 140.

Further, the rear of the blade housing 110 may be a direction opposite to the foregoing front, and, with respect to FIG. 2, the rear of the blade housing 110 may refer to a direction from the blade 120 toward the cap 150.

The clip 130 refers to a component to prevent the plurality of blades 120 from being detached from the blade housing 110, and may be coupled to the blade housing 110 in various ways according to embodiments. Further, instead of the clip 130, an additional component (e.g., a cover member coupled to the upper surface of the blade housing 110) may be used to prevent the detachment of the plurality of blades 120 from the blade housing 110.

The guard 140 may be provided on the front upper surface of the blade housing 110.

The guard 140 comes into close contact with a user's skin during the shaving process and pulls the skin to enhance a shaving effect of the blade 120. To pull the user's skin more effectively, the guard 140 may include an embossed or engraved pattern on the upper surface thereof, and the upper surface of the guard 140 may be formed of a material such as rubber or silicone.

The cap 150 may be provided on the rear upper surface of the blade housing 110.

The cap 150 may include a lubricating band exposed to the upper surface of the blade housing 110. The lubricating band includes a lubricating material and applies the lubricating substance to a skin surface that the blade 120 has passed over during the shaving process. The lubricating material may include ingredients for protecting the skin after shaving.

Referring to FIGS. 3 and 4, the blade housing 110 may include a cam support portion 111 on the lower surface thereof, and a cam 112 protruding from the cam support portion 111. In the state that the razor cartridge 10 and the razor handle 20 are coupled, the cam 112 may be in contact with a plunger 240 (to be described later) to restrict a pivot motion of the razor cartridge 10. The cam support portion 111 may be provided at a central portion on the lower surface of the blade housing 110 and support a base portion of the plurality of blades 120. The cam support portion 111 may be formed with a mark 113 (e.g., an arrow mark) for indicating a coupling direction of the handle head 22 of the razor handle 20.

The razor cartridge 10 may include a connector 180. The connector 180 refers to a component to detachably couple with the handle head 22 of the razor handle 20. The connector 180 may be coupled to the blade housing 110 or formed integrally with the blade housing 110 on the lower surface of the blade housing 110. Alternatively, the connector 180 may be provided in a fixed configuration in the blade housing 110.

The connector 180 may be positioned not to overlap with the blades 120 so that shaving residues (e.g., shaving cream, cut hair, etc.) can be effectively discharged along with washing water through a space between the plurality of blades 120.

The connector 180 may include a pair of guide posts 181, a pair of plunger opposite ends 182, and a pair of guide surfaces 183.

The pair of guide posts 181 may be formed to protrude from the blade housing 110 while being spaced apart from each other in the longitudinal direction. The space between the pair of guide posts 181 forms a space for the plunger 240 of the razor handle 20 (to be described later) to enter. In order for the plunger 240 to smoothly enter, a first side surface of each guide post 181 (i.e., a surface facing the other guide post 181) may form an inclined surface so that the space between the pair of guide posts 181 can become narrower gradually toward the cam 112.

The pair of plunger opposite ends 182 may be formed to protrude from the blade housing 110 while being longitudinally spaced apart from each other between the pair of guide posts 181. The plunger opposite end 182 may be formed to have a height difference from the guide post 181 so that the guide post 181 can protrude further from the blade housing 110 than the plunger opposite end 182. In the state that the razor cartridge 10 and the razor handle 20 are coupled, the plunger opposite ends 182 may be adjacent to the plunger 240 (to be described later), or may support the plunger 240.

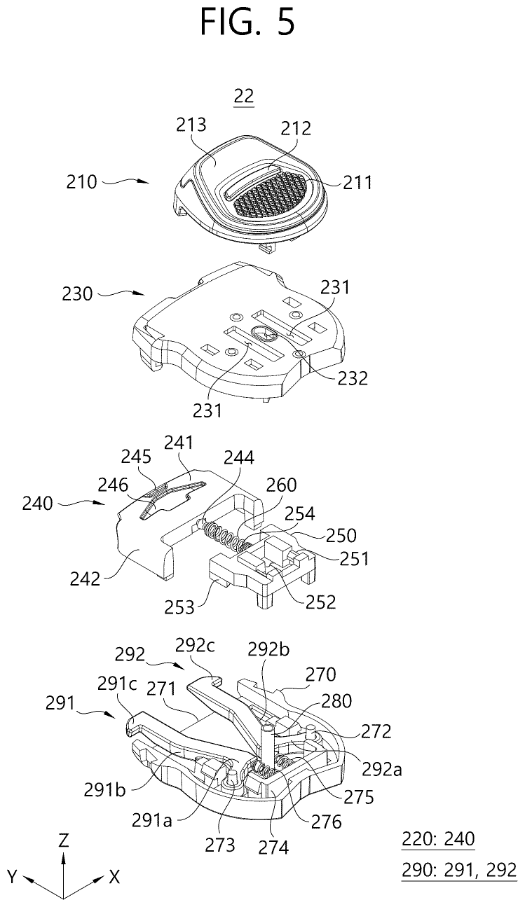

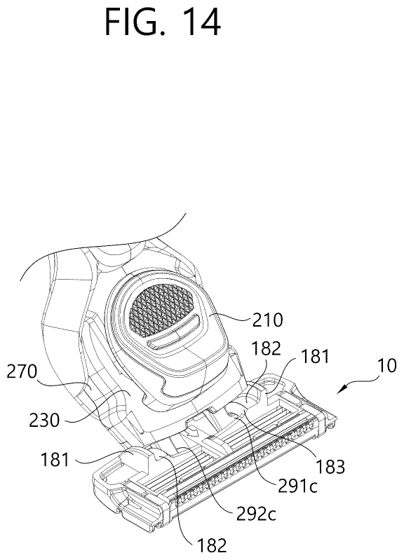

Referring to FIGS. 3 and 4, the pair of guide surfaces 183 form an inclined surface from the plunger opposite ends 182, respectively, so that a space between the pair of guide surfaces 183 can become narrower gradually toward the cam 112. An accommodating space 184 (see FIG. 4) is formed between each of the guide surfaces 183 and the blade housing 110 to accommodate a first end portion 291c (see FIG. 5) and a second end portion 292c (see FIG. 5) of a coupling portion 290 (to be described later). The pair of guide surfaces 183 guides the first end portion 291c and the second end portion 292c of the coupling portion 290 (to be described later) to move toward each other when they enter between the pair of guide surfaces 183. When the first end portion 291c and the second end portion 292c have passed the pair of guide surfaces 183, they move away from each other again and enter the accommodating space 184, thereby completing the coupling between the razor cartridge 10 and the razor handle 20 (see FIG. 14).

Referring to FIG. 3, a distance A1 between the pair of guide surfaces 183 may be determined within a range of about 16.8 mm to 25.2 mm. For example, A1 may be about 21 mm. The distance A1 between the pair of guide surfaces 183 may refer to a distance between the boundaries of the plunger opposite end 182 and the guide surface 183.

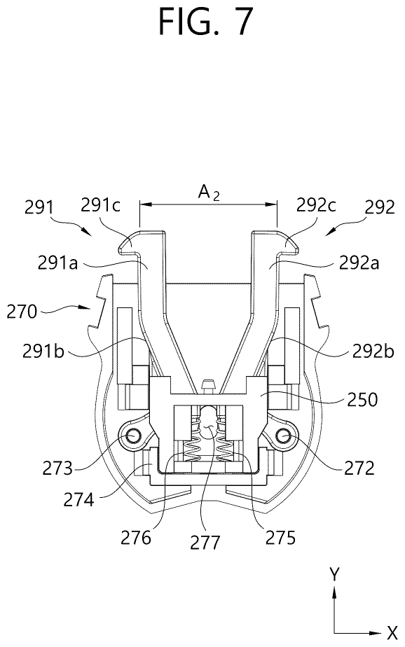

To allow the first end portion 291c and the second end portion 292c to smoothly enter between the pair of guide surfaces 183, a distance A2 (see FIG. 7) between the first end portion 291c and the second end portion 292c may be formed shorter than the distance A1 between the pair of guide surfaces 183. The distance A2 between the first end portion 291c and the second end portion 292c may be determined within a range from 13.52 mm to 20.28 mm. For example, A2 may be 16.9 mm. The distance A2 between the first end portion 291c and the second end portion 292c may refer to a distance between a point where an incline surface of the first end portion 291c in the first arm 291 starts toward a negative X-axis direction (see FIG. 7) and a point where an inclined surface of the second end portion 292c in the second arm 292 starts toward a positive X-axis direction (see FIG. 7).

A pair of accommodating spaces 184 may accommodate the first end portion 291c and the second end portion 292c, thereby forming a pivot axis of the razor cartridge 10 with respect to the razor handle 20. According to an embodiment, the pair of accommodating spaces 184 are positioned adjacent to the upper surface of the blade housing 110, and thus the pivot axis of the razor cartridge 10 is formed close to a shaving plane where shaving is actually performed, thereby achieving a close shave.

Regarding the coupling, detachment, etc. between the connector 180 and the coupling portion 290, more detailed descriptions will be made later.

The razor cartridge 10 may additionally include a trimming blade 160 and a trimming guard 170.

The trimming blade 160 is accommodated between the trimming guard 170 and the blade housing 110 so that the cutting edge thereof can be exposed toward the rear of the razor cartridge 10. The trimming blade 160 may be used to cut hair in a relatively narrow region, such as sideburns, a mustache, etc. The trimming guard 170 may be formed with a plurality of combs arranged side by side in the longitudinal direction to align the hair before being cut by the trimming blade 160.

Below, the handle head 22 of the razor handle 20 will be described.

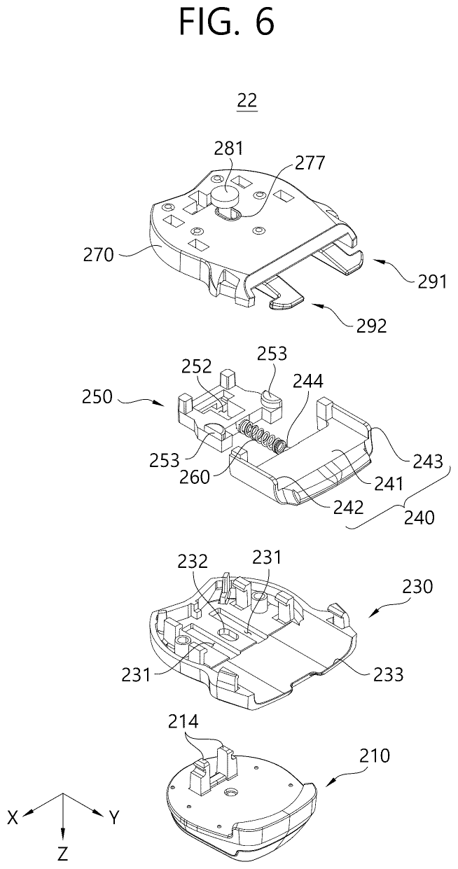

FIG. 5 is an exploded perspective view of the handle head 22 according to an embodiment of the disclosure, viewed from above, and FIG. 6 is an exploded perspective view of the handle head 22 according to an embodiment of the disclosure, viewed from below.

Referring to FIGS. 5 and 6, the handle head 22 according to an embodiment of the disclosure may include an operating portion 210, a restoring force providing portion 220, and the coupling portion 290.

The operating portion 210 is configured to operate the coupling portion 290 by moving a pusher 250, which will be described later. A user may operate the operating portion 210 in the state that the razor cartridge 10 and the razor handle 20 are coupled, thereby detaching the razor cartridge 10 and the razor handle 20. In this regard, details will be described later.

Referring to FIG. 5, the operating portion 210 is located in the upper portion of the handle head 22 (see FIG. 1), and has an upper surface formed with, but not limited to, a friction surface 211 for increasing friction with a user's finger, a stepped portion 212 for preventing the user's finger from slipping, and an upward inclined surface 213 for supporting the user's finger. The friction surface 211, the stepped portion 212 and the inclined surface 213 allow a user to more easily move the operating portion 210 when s/he pushes the operating portion 210 with a finger (or a thumb) in a first direction. Here, the first direction may refer to a direction from the handle head 22 toward the razor cartridge 10. Referring to FIGS. 5 and 6, the first direction is a positive Y-axis direction. An X-axis refers to a longitudinal direction perpendicular to the Y-axis on a horizontal plane, a positive Z-axis direction refers to an upward direction, and a negative Z-axis direction refers to a downward direction.

Referring to FIG. 6, the operating portion 210 has a lower surface provided with a pusher coupling portion 214 extending downwards (in the negative Z-axis direction). The pusher coupling portion 214 couples with the pusher 250 penetrating a plunger upper housing 230 (to be described later) and accommodated in the plunger housings 230 and 270. Accordingly, the pusher 250 accommodated in the plunger housings 230 and 270 moves integrally with the operating portion 210 located outside the plunger housings 230 and 270.

The restoring force providing portion 220 is configured to provide a restoring force to the razor cartridge 10, which is pivotable about the razor handle 20 within a certain angular range. Referring to FIGS. 5 and 6, the handle head 22 according to an embodiment of the disclosure includes the plunger 240 as the restoring force providing portion 220, but is not limited thereto, and the restoring force providing portion 220 may include a cantilever structure and/or a rubber member having an elastic force to provide the restoring force to the razor cartridge 10. Hereinafter, for convenience of description, an example that the restoring force providing portion 220 includes the plunger 240 will be described.

The plunger housings 230 and 270 include the plunger upper housing 230 and a plunger lower housing 270. The plunger upper housing 230 and the plunger lower housing 270 form a space in which the plunger 240, the pusher 250 and the coupling portion 290 are accommodated.

Referring to FIG. 5, the plunger upper housing 230 may have a pusher coupling slot 231 and a first pin through slot 232 formed therethrough. The pusher coupling slot 231 and the first pin through slot 232 may be formed long along the first direction.

The pusher coupling portion 214 of the operating portion 210 passes through the pusher coupling slot 231, and the first end of the pin 280 passes through the first pin through slot 232 and is coupled to the operating portion 210. The pusher coupling portion 214 is movable in the first direction along the pusher coupling slot 231. Accordingly, the operating portion 210 is movable in the first direction with respect to the plunger upper housing 230.

Referring to FIG. 6, a distal end portion 233 of the plunger upper housing 230 may be open in the first direction such that the plunger 240 and the coupling portion 290 are at least partially exposed or appear or disappear from the plunger upper housing 230.

Referring back to FIG. 5, a distal end portion 271 of the plunger lower housing 270 may also be open in the first direction such that the plunger 240 and the coupling portion 290 are at least partially exposed or appear or disappear from the plunger lower housing 270.

The plunger lower housing 270 may be internally formed with a first arm rotation pin 273 and a second arm rotation pin 272, on which a first arm 291 and a second arm 292 of the coupling portion 290 are rotatably installed.

Further, the plunger lower housing 270 may be internally formed with a support base 274 to determine a retreat limit of the pusher 250 in the first direction. The support base 274 may be provided between the first arm rotation pin 273 and the second arm rotation pin 272, without restricting the intended rotation of the first arm 291 and the second arm 292. Further, the first arm 291 may be elastically supported by an elastic member 276 provided between the support base 274 and the first arm 291, and the second arm 292 may be elastically supported by an elastic member 275 provided between the support base 274 and the second arm 292. In other words, the first arm 291 and the second arm 292 may be elastically supported by the support base 274. The first arm 291 and the second arm 292 may be elastically supported in a direction in which the elastic members 275 and 276 is stretched, respectively. In other words, the elastic members 275 and 276 may provide a restoring force in a direction in which the first end portion 291c and the second end portion 292c exposed to the outside of the plunger housings 230 and 270 move away from each other.

Referring to FIGS. 5 and 6, the plunger lower housing 270 may have the second pin through slot 277 formed therethrough. The second pin through slot 277 may be formed long along the first direction.

The second end of the pin 280 may be exposed to the lower portion of the plunger lower housing 270 (in the negative Z-axis direction) through the second pin through slot 277, and the second end of the pin 280 is provided with a flange 281 having a diameter larger than the width of the second pin through slot 277 to prevent the second end of the pin 280 from entering the plunger housings 230 and 270.

Referring to FIG. 5, the pusher 250 may include an operating-portion coupling portion 251 coupled to the pusher coupling portion 214 of the operating portion 210. FIGS. 5 and 6 illustrate an example that the pusher coupling portion 214 and the operating-portion coupling portion 251 have a hook-coupled structure, but the pusher coupling portion 214 and the operating-portion coupling portion 251 may be modified to have various coupling structures.

Further, the pusher 250 may be formed with a third pin through slot 252 through which the central portion of the pin 280 passes.

Referring to FIG. 5 and FIG. 6, a pair of driving protrusions 253 spaced apart in the longitudinal direction are formed on the lower surface of the pusher 250. The pair of driving protrusions 253 are positioned to be in contact with a first driving surface 291b of the first arm 291 and a second driving surface 292b of the second arm 292, respectively. As the pusher 250 moves forward/backward, the driving protrusion 253 interacts with the first driving surface 291b and the second driving surface 292b so that the first arm 291 can rotate around the first arm rotation pin 273, and the second arm 292 can rotate around the second arm rotation pin 272. In this regard, detailed descriptions will be made later.

The pusher 250 may be formed with a first elastic member mounting portion 254 at a distal end portion thereof, on which the first end of an elastic member 260 for elastically supporting the pusher 250 and the plunger 240 is installed.

Referring to FIGS. 5 and 6, the plunger 240 may include an upper cover 241, a first lateral wall 243 extending downwardly from the first side of the upper cover 241 and a second lateral wall 242 extending downwardly from the second side of the upper cover 241.

The plunger 240 may be provided to slide and move along the first direction within the plunger housings 230 and 270. In the state that the plunger 240 is elastically supported by the elastic member 260 and is positioned at a forward limit point in the first direction, the upper cover 241 may be positioned to cover all or a portion of the first end portion 291c of the first arm 291 and the second end portion 292c of the second arm 292. In the state that the elastic member 260 elastically supporting the plunger 240 is compressed and the plunger 240 is positioned at a retreat limit point in the first direction, the upper cover 241 may be positioned to expose the first end portion 291c of the first arm 291 and the second end portion 292c of the second arm 292 to the outside.

The upper cover 241 may include a cam contact portion 245 formed at a distal end portion thereof and comes into contact with the cam 112 of the razor cartridge 10. The cam contact portion 245 may be shaped to define the pivot motion of the razor cartridge 10 relative to the razor handle 20 by interacting with the shape of the cam 112. The cam contact portion 245 may be engraved and/or embossed relative to the upper cover 241.

The upper cover 241 may include a mark 246 (e.g., an arrow mark) formed to indicate the coupling direction of the handle head 22 to the razor cartridge 10. The mark 246 allows a user to easily recognize the coupling direction of the razor handle 20 to the razor cartridge 10. The mark 246 may be formed at a position to be aligned with the mark 113 formed in the razor cartridge 10 during the coupling process between the razor cartridge 10 and the razor handle 20 in the coupling direction, thereby allowing a user to more clearly recognize the coupling direction of the razor handle 20 to the razor cartridge 10.

The plunger 240 may include a second elastic member installation portion 244 formed at the rear end thereof, on which the second end of the elastic member 260 for elastically supporting the pusher 250 and the plunger 240 is installed.

Referring to FIG. 5, the coupling portion 290 may include the first arm 291 and the second arm 292 which are spaced from each other in the longitudinal direction.

In the embodiment shown in FIG. 5, the coupling portion 290 includes the first arm 291 and the second arm 292, but the disclosure is not limited thereto. The coupling portion 290 may employ various configurations to detachably couple with the razor cartridge 10. For example, besides the pair of arms 291 and 292, the coupling portion 290 may use a latch coupling method, a hook coupling method, a snap-fit coupling method, a boss coupling method, a magnetic-based coupling method, etc. to detachably couple with the razor cartridge 10. However, for convenience of description, the following description will be made based on an example that the coupling portion 290 includes the first arm 291 and the second arm 292.

Further, as described above, the restoring force providing portion 220 may be included in the razor handle 20, but the disclosure is not limited thereto. According to an embodiment, the restoring force providing portion 220 may be included in the razor cartridge 10.

In this case, the restoring force providing portion 220 may be positioned on the connector 180, and the connector 180 may be pivotably connected to the blade housing 110. Further, as described above, the restoring force providing portion 220 may include a cantilever structure and/or a rubber member providing an elastic force besides the elastically supported plunger 240, thereby providing the restoring force to the razor cartridge 10. When the restoring force providing portion 220 is provided in the razor cartridge 10, the restoring force providing portion 220 may cover at least a part of the coupling portion 290 in the process of coupling or detaching the razor cartridge 10 and the razor handle 20. In the state that the razor cartridge 10 and the razor handle 20 are coupled, the restoring force providing portion 220 may cover at least a part of the coupling portion 290.

The first arm 291 may include a first driving arm 291a, the first driving surface 291b, and the first end portion 291c.

The first driving arm 291a has a first side rotatably installed on the first arm rotation pin 273. The first driving arm 291a extends toward the open distal end portions of the plunger housings 230 and 270.

The first driving surface 291b may form at least a portion of an outer surface of the first driving arm 291a, and may be formed to form an outward slope in the first direction, but is not necessarily limited thereto.

The first end portion 291c is formed on a second side of the first driving arm 291a, which is exposed to the outside of the plunger housings 230 and 270. The first end portion 291c may be formed to protrude outwardly from the first driving arm 291a. The front side of the first end portion 291c may be formed to be inclined toward the negative X-axis direction, and the rear side of the first end portion 291c may form the stepped portion approximately perpendicular to the first driving arm 291a, but is not necessarily limited thereto. For example, when the first end portion 291c is detachably coupled to the razor cartridge 10 by a shell-bearing coupling method, the first end portion 291c may include a shell-bearing.

In the case where the front side of the first end portion 291c is formed to be inclined toward the negative X-axis direction, when the razor cartridge 10 and the razor handle 20 are coupled, the first end portion 291c smoothly moves along the guide post 181, the plunger opposite end 182 and the guide surface 183 of the connector 180, and the first driving arm 291a naturally rotates around the first arm rotation pin 273, thereby inducing natural coupling between the razor cartridge 10 and the razor handle 20. However, the front side shape of the first end portion 291c may be varied depending on the structure, etc. of the connector 180, and may be configured without the inclined surface toward the negative X-axis direction.

When the first end portion 291c includes the stepped portion formed on the rear side thereof, which is approximately perpendicular to the first driving arm 291a, the first end portion 291c is prevented from being disengaged in the negative Y-axis direction while being inserted in the accommodating space 184, so that the razor cartridge 10 and the razor handle 20 can be maintained in the coupled state. The rear side of the first end portion 291c may be modified to have various shapes so as not to form the stepped portion that is approximately perpendicular to the first driving arm 291a, and to prevent the first end portion 291c from being disengaged in the negative Y-axis direction while the first end portion 291c is inserted in the accommodating space 184.

The second arm 292 may include a second driving arm 292a, the second driving surface 292b, and the second end portion 292c.

The second driving arm 292a has a first side rotatably installed on the second arm rotation pin 272. The second driving arm 292a extends toward the open distal end portions of the plunger housings 230 and 270.

The second driving surface 292b may form at least a portion of an outer surface of the second driving arm 292a, and may be formed to form an outward slope in the first direction, but is not necessarily limited thereto.

The second end portion 292c is formed on a second side of the second driving arm 292a, which is exposed to the outside of the plunger housings 230 and 270. The second end portion 292c may be formed to protrude outwardly from the second driving arm 292a. The front side of the second end portion 292c may be formed to be inclined rearwards, and the rear side of the second end portion 292c may form the stepped portion approximately perpendicular to the second driving arm 292a, but is not necessarily limited thereto. For example, when the second end portion 292c is detachably coupled to the razor cartridge 10 by a shell-bearing coupling method, the second end portion 292c may include a shell-bearing.

In the case where the front side of the second end portion 292c is formed to be inclined toward the positive X-axis direction, when the razor cartridge 10 and the razor handle 20 are coupled, the second end portion 292c smoothly moves along the guide post 181, the plunger opposite end 182 and the guide surface 183 of the connector 180, and the second driving arm 292a naturally rotates around the second arm rotation pin 272, thereby inducing natural coupling between the razor cartridge 10 and the razor handle 20. However, the front side shape of the second end portion 292c may be varied depending on the structure, etc. of the connector 180, and may be configured without the inclined surface toward the positive X-axis direction.

When the second end portion 292c includes the stepped portion formed on the rear side thereof, which is approximately perpendicular to the second driving arm 292a, the second end portion 292c is prevented from being disengaged in the negative Y-axis direction while being inserted in the accommodating space 184, so that the razor cartridge 10 and the razor handle 20 are maintained in the coupled state. The rear side of the second end portion 292c may be modified to have various shapes so as not to form the stepped portion that is approximately perpendicular to the second driving arm 292a, and to prevent the second end portion 292c from being disengaged in the negative Y-axis direction while the second end portion 292c is inserted in the accommodating space 184.

FIG. 7 is a view showing a position relationship among the first arm 291, the second arm 292, and the pusher 250 in a neutral state.

The neutral state in FIG. 7 refers to a state in which no other external force is applied to the pusher 250, the first arm 291 and the second arm 292. Therefore, in the neutral state, the pusher 250 may be located at or adjacent to the retreat limit point, and the first arm 291 and the second arm 292 may be spread outward as much as possible with respect to each other.

The detached state where the razor handle 20 and the razor cartridge 10 are completely detached and/or the coupled state where the razor handle 20 and the razor cartridge 10 are completely coupled may be the neutral state.

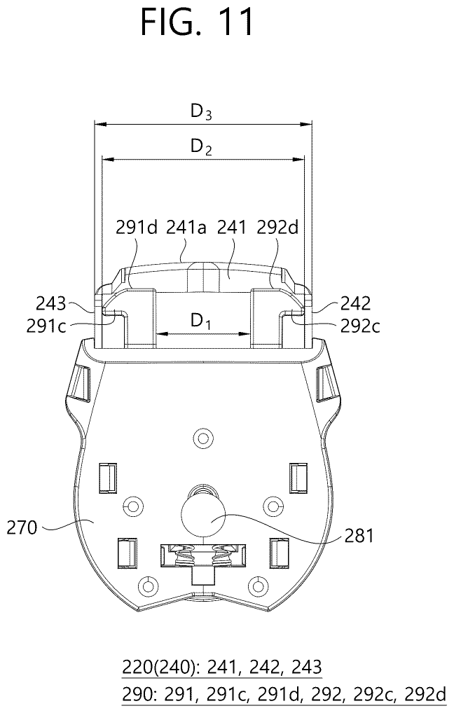

Meanwhile, even in the same neutral state, the position of the plunger 240 may be varied depending on whether it is in the detached state or the coupled state. For example, in the detached state, the position of the plunger 240 may be positioned forward so that the first end portion 291c and the second end portion 292c can be covered with the plunger 240 (see FIG. 11), and in the coupled state, the position of the plunger 240 may retreat so that the first end portion 291c and the second end portion 292c can be exposed to the outside of the plunger 240.

On the other hand, the detached state and/or the coupled state may not be the neutral state. For example, when the first end portion 291c and the second end portion 292c in the detached state are supported on the first lateral wall 243 and the second lateral wall 242 of the plunger 240, respectively, a distance between the first end portion 291c and the second end portion 292c in the detached state may be shorter than a distance between the first end portion 291c and the second end portion 292c in the neutral state. Alternatively, in the coupled state, the first driving arm 291a, the first end portion 291c, the second driving arm 292a and/or the second end portion 292c may be supported on the connector 180, for example, on the guide surface 183, such that a distance between the first end portion 291c and the second end portion 292c in the coupled state may be shorter than the distance between the first end portion 291c and the second end portion 292c in the neutral state.

However, when the first end portion 291c and the second end portion 292c in the detached state are not supported by the first lateral wall 243 and the second lateral wall 242 of the plunger 240, respectively, but positioned adjacent to the first lateral wall 243 and the second lateral wall 242, the distance between the first end portion 291c and the second end portion 292c may be substantially the same in the detached state and the neutral state, or in the detached state, the neutral state and the coupled state.

Referring to FIG. 7, in the detached state and/or the coupled state, the pusher 250 may be positioned at the retreat limit point or adjacent to the retreat limit point in the first direction. In this case, the driving protrusion 253 of the pusher 250 may be positioned at the innermost point of the first driving surface 291b and the innermost point of the second driving surface 292b. Further, the pusher 250 may be supported on the support base 274.

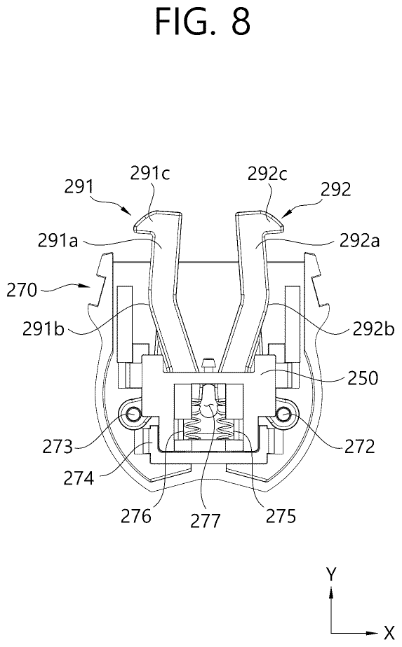

FIG. 8 is a view showing a position relationship among the first arm 291, the second arm 292 and the pusher 250 in a coupling process. In this specification, the coupling process refers to the process in which the razor handle 20 and the razor cartridge 10 are connected, in other words, an intermediate process from the detached state toward the coupled state.

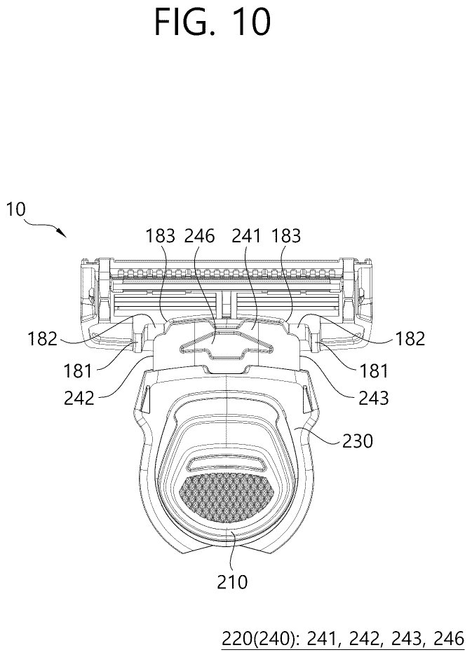

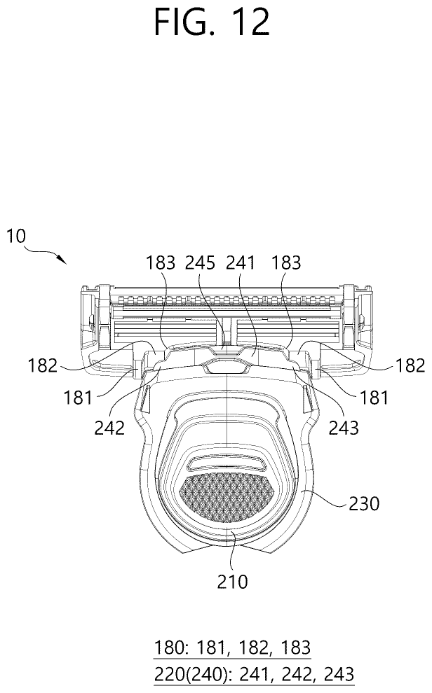

After a distal end portion 241a of the plunger 240 comes into contact with the blade housing 110 as the connector 180 of the razor cartridge 10 and the handle head 22 approach each other, the plunger 240 retreats rearwardly in the first direction toward the inside of the plunger housings 230 and 270 while being supported by the plunger opposite end 182 and/or the guide surface 183 (see FIGS. 10 and 12). The contact between the distal end portion 241a of the plunger 240 and the blade housing 110 may occur before the contact between the distal end portions 291d and 292d of the arms 291 and 292 and the connector 180. In this case, the contact between the distal end portions 291d and 292d of the arms 291 and 292 and the connector 180 may be made after the plunger 240 has retreated a predetermined distance rearwardly in the first direction.

Alternatively, the contact between the distal end portion 241a of the plunger 240 and the blade housing 110 may occur simultaneously with the contact between the distal end portions 291d and 292d of the arms 291 and 292 and the connector 180.

Alternatively, the contact between the distal end portions 291d and 292d of the arms 291 and 292 and the connector 180 may occur before the contact between the distal end portion 241a of the plunger 240 and the blade housing 110.

The lower surface region of the blade housing 110 to be in contact with the plunger 240 may be formed to correspond to at least a portion of the shape of the distal end portion 241a of the plunger 240. In this way, the plunger 240 and the blade housing 110 may be in stable contact with each other, and the coupling positions of the connector 180 and the handle head 22 may be naturally aligned. Further, a user's recognition for the alignment direction of the connector 180 and the handle head 22 may be improved.

For example, the plunger opposite end 182 and/or the guide surface 183 of the connector 180 may be shaped to correspond to the shapes of both sides of the distal end portion 241a of the plunger 240 and the lateral walls 242 and 243 of the plunger 240. Alternatively, the distal end portion 241a of the plunger 240 may be formed convexly so as to make a longitudinal (X-directional) width become narrower in the first direction, and the lower surface region of the blade housing 110 to be in contact with the distal end portion 241a may be formed concavely so as to be aligned with the distal end portion 241a.

As the connector 180 and the handle head 22 approach further each other, the first end portion 291c of the first arm 291 and the second end portion 292c of the second arm 292 pass along the guide surface 183 or pass the plunger opposite end 182 and the guide surface 183 in sequence, and, as shown in FIG. 8, the first arm 291 and the second arm 292 rotate about the first arm rotation pin 273 and the second arm rotation pin 272, respectively, such that the first end portion 291c and the second end portion 292c become closer. The elastic members 275 and 276 provide restoring forces to the first arm 291 and the second arm 292, respectively, in a direction of increasing the distance between the first end portion 291c and the second end portion 292c, so that the first end portion 291c and the second end portion 292c can move while maintaining the contact with the guide surface 183.

When each of the first end portion 291c and the second end portion 292c passes through the guide surface 183, the first end portion 291c and the second end portion 292c move back to the neutral state (the coupled state) illustrated in FIG. 7 while entering the accommodating space 184 by the restoring force provided from the elastic members 275 and 276.

Referring back to FIG. 8, in the process of coupling the razor cartridge 10 and the razor handle 20, the pusher 250 may not move from the neutral state. In other words, a user may complete the coupling between the razor cartridge 10 and the razor handle 20 even though s/he does not close the first arm 291 and the second arm 292 together by manipulating the operating portion 210 in the process of coupling the razor cartridge 10 and the razor handle 20.

The connector 180 includes the guide surface 183, thereby guiding the first end portion 291c of the first arm 291 and the second end portion 292c of the second arm 292 to naturally enter the accommodating space 184 by a user's simple motion of bringing the razor cartridge 10 and the razor handle 20 closer to each other.

Further, the handle head 22 includes the elastic members 275 and 276 that provide the restoring force to the first arm 291 and the second arm 292, thereby inducing the first end portion 291c and the second end portion 292c to naturally enter the accommodating space 184 immediately after passing the guide surface 183 by a user's simple motion of bring the razor cartridge 10 and the razor handle 20 closer to each other.

Further, even with a user's simple motion of bringing the razor cartridge 10 and the razor handle 20 closer to each other, the plunger 240 is supported on the blade housing 110 and retreats toward the inside of the plunger housings 230 and 270, and the first end portion 291c of the first arm 291 and the second end portion 292c of the second arm 292 are automatically exposed from the plunger 240 and coupled to the connector 180. In other words, the first end portion 291c of the first arm 291 and the second end portion 292c of the second arm 292 are covered with the plunger 240 in the detached state so as not to be exposed to the outside, but a user does not need to separately operate the plunger 240 so as to couple the razor cartridge 10 and the razor handle 20.

Accordingly, a user may complete the coupling of the razor cartridge 10 and the razor handle 20 by only bring the razor cartridge 10 and the razor handle 20 closer to each other without manipulating the operating portion 210 or the plunger 240 during the coupling process of the razor cartridge 10 and the razor handle 20.

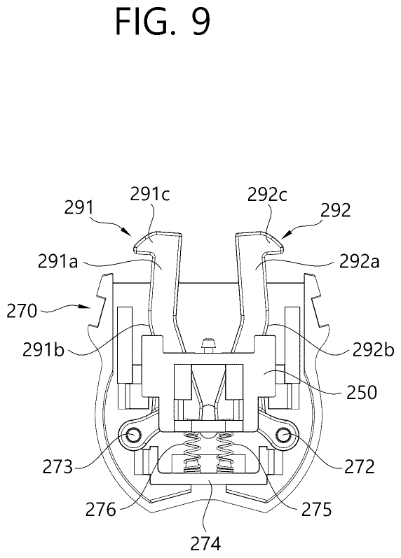

FIG. 9 is a view showing a position relationship among the first arm 291, the second arm 292 and the pusher 250 during the detachment process. In this specification, the detachment process refers to the process in which the razor handle 20 and the razor cartridge 10 are detached, in other words, an intermediate process from the coupled state to the detached state.

To detach the razor cartridge 10 and the razor handle 20, a user may move the operating portion 210 forward in the first direction, thereby causing the pusher 250 to move forward in the first direction.

Referring to FIG. 9, as the pusher 250 moves forward in the first direction, the driving protrusion 253 of the pusher 250 moves along the first driving surface 291b and the second driving surface 292b while moving forward in the first direction. As the driving protrusion 253 moves forward in the first direction, the first arm 291 rotates clockwise about the first arm rotation pin 273, and the second arm 292 rotates counterclockwise about the second arm rotation pin 272, thereby getting the first end portion 291c and the second end portion 292c closer to each other gradually.

Because the pusher 250 moves integrally with the operating portion 210, a user may make the operating portion 210 move forward in the first direction to bring the first end portion 291c and the second end portion 292c closer to each other. When a user wants to detach the razor cartridge 10 and the razor handle 20, s/he may move the operating portion 210 forward in the first direction to bring the first end portion 291c and the second end portion 292c closer to each other, thereby detaching the first end portion 291c and the second end portion 292c from the connector 180 of the razor cartridge 10.

In the state of FIG. 9, when a user removes the force for moving the operating portion 210 forward in the first direction, the first arm 291 and the second arm 292 return back to the state of FIG. 7 by the restoring force of the elastic members 275 and 276. As the first arm 291 and the second arm 292 return back to the state of FIG. 7, the pusher 250 also retreats and becomes positioned in the state of FIG. 7 by the interaction between the driving protrusion 253 and the first and second driving surfaces 291b and 292b. Along with the retreat of the pusher 250, the operating portion 210 also retreats and becomes positioned at the retreat limit point.

FIG. 10 is a plan view showing a state immediately before the handle head 22 is coupled to the razor cartridge 10 according to an embodiment of the disclosure, and FIG. 11 is a bottom view showing the handle head 22 in the state of FIG. 10.

In FIGS. 10 and 11, the razor cartridge 10 and the handle head 22 are in the state just before being coupled to each other, and thus the plunger 240, the first arm 291 and the second arm 292 are assumed to be in the ‘detached state’ mentioned above with reference to FIG. 7.

Referring to FIGS. 10 and 11, in the state that the handle head 22 is detached from the razor cartridge 10, the first arm 291 and the second arm 292 exposed from the distal end portion 241a of the plunger housings 230 and 270 are not exposed to the outside by the plunger 240. Because the first arm 291 and the second arm 292 are not exposed to the outside, the first arm 291 and the second arm 292 are protected from external impact, thereby extending the lifespan of the razor handle 20 and improving aesthetics in an outer appearance.

Referring to FIG. 11, in the state that the handle head 22 is detached from the razor cartridge 10, the first arm 291 may be supported or in contact with the first lateral wall 243 of the plunger 240, and the second arm 292 may be supported or in contact with the second lateral wall 242 of the plunger 240. Alternatively, in the state that the handle head 22 is detached from the razor cartridge 10, the first arm 291 may be spaced apart from the first lateral wall 243 of the plunger 240, and the second arm 292 may be spaced apart from the second lateral wall 242 of the plunger 240.

Further, referring to FIG. 11, in the state that the handle head 22 is detached from the razor cartridge 10, the upper cover 241 may cover the upper portion of the coupling portion 290. For example, the distal end portion 291d of the first arm 291 and the distal end portion 292d of the second arm 292 may be positioned reward than the distal end portion 241a of the plunger 240 in the first direction, such that the plunger 240 covers the first arm 291 and the second arm 292 from above. Alternatively, in the state that the handle head 22 is detached from the razor cartridge 10, the distal end portion 291d of the first arm 291 and the distal end portion 292d of the second arm 292 may be located at the same position as the distal end portion 241a of the plunger 240 in the first direction.

Further, in the process of coupling the handle head 22 and the razor cartridge 10, the contact between the distal end portion 241a of the plunger 240 and the blade housing 110 may occur before the contact between the distal end portions 291d and 292d of the arms 291 and 292 and the connector 180. When the contact between the distal end portion 241a of the plunger 240 and the blade housing 110 occurs, natural alignment may be induced at the coupling position between the razor cartridge 10 and the razor handle 20, and a user's recognition for the direction of aligning the razor cartridge 10 and the razor handle 20 may be improved. Further, referring to FIG. 11, in the state that the razor cartridge 10 is detached from the handle head 22, an outer distance D2 between the first end portion 291c and the second end portion 292c may be smaller than a longitudinal width D3 of the plunger 240 so that the plunger 240 can cover the first arm 291 and the second arm 292 from above. Alternatively, in the state that the razor cartridge 10 is detached from the handle head 22, the outer distance D2 between the first end portion 291c and the second end portion 292c may be substantially equal to the longitudinal width D3 of the plunger 240. As examples shown in FIGS. 10 and 11, the restoring force providing portion 220 includes the plunger 240, but the disclosure is not limited thereto. The restoring force providing portion 220 may include a cantilever structure and/or a rubber member providing an elastic force, etc., to provide the restoring force to the razor cartridge 10.

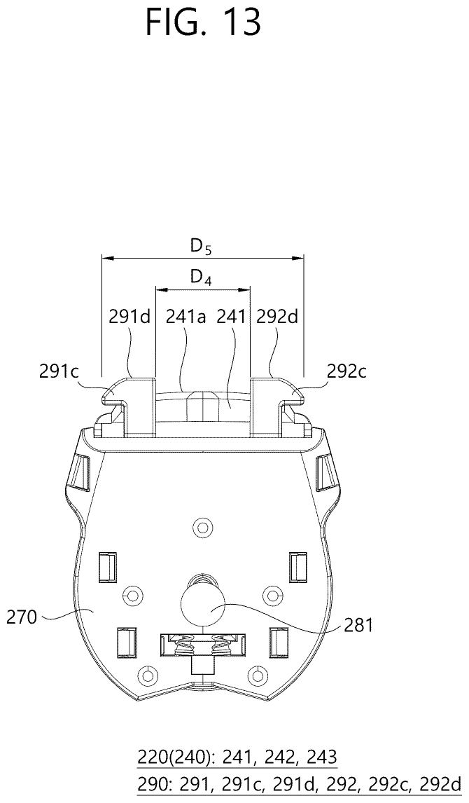

FIG. 12 is a plan view showing the state that the handle head 22 is coupled to the razor cartridge 10 according to an embodiment of the disclosure, FIG. 13 is a bottom view showing the handle head 22 in the state of FIG. 12, and FIG. 14 is a perspective view showing a portion of the razor assembly 1 from which the plunger 240 is omitted from the state of FIG. 12

Referring to FIG. 12, when the handle head 22 is coupled to the razor cartridge 10, the plunger 240 is positioned between the pair of guide posts 181. Further, the first lateral wall 243 and the second lateral wall 242 of the plunger 240 face the pair of plunger opposite ends 182 and 182, respectively. The first lateral wall 243 and the second lateral wall 242 may be positioned adjacent to the plunger opposite end 182 and 182, respectively, or may be supported on the plunger opposite end 182.

Referring to FIGS. 12 to 14, the process of coupling the razor cartridge 10 and the razor handle 20 will be described. The plunger 240 is supported by the connector 180 and retreats toward the inside of the plunger housings 230 and 270. As the plunger 240 retreats, the first arm 291 and the second arm 292 are exposed, and the first end portion 291c and the second end portion 292c come into contact with the pair of guide surfaces 183 and 294, respectively. As the razor cartridge 10 and the razor handle 20 get closer, the first arm 291 and the second arm 292 rotate so that the distance between the first end portion 291c and the second end portion 292c can get closer until the first end portion 291c and the second end portion 292c pass the pair of guide surfaces 183. After the first end portion 291c and the second end portion 292c pass the pair of guide surfaces 183, the first arm 291 and the second arm 292 are rotated so that the first end portion 291c and the second end portion 292c can move away from each other by the restoring force provided from the elastic members 275 and 276, and as illustrated in FIG. 14, each of the first end portion 291c and the second end portion 292c enters the accommodating space 184 (see FIG. 4) between the guide surface 183 and the blade housing 110, thereby completing the coupling between the coupling portion 290 and the connector 180.

In the neutral state, when the first arm 291 and the second arm 292 are supported by or in contact with the first lateral wall 243 and the second lateral wall 242 of the plunger 240, the plunger 240 retreats in the process of coupling the coupling portion 290 and the connector 180, thereby releasing the support or contact state between the first arm 291 and the first lateral wall 243 and the support or contact state between the second arm 292 and the second lateral wall 242. The coupling between the coupling portion 290 and the connector 180 may be performed simultaneously with the release of the support or contact state between the first arm 291 and the first lateral wall 243 and the release of the support or contact state between the second arm 292 and the second lateral wall 242.

Meanwhile, in the neutral state, when the first arm 291 and the second arm 292 are not supported or in contact with the first lateral wall 243 and the second lateral wall 242 of the plunger 240, and the first end portion 291c and the second end portion 292c are spaced apart from the first lateral wall 243 and the second lateral wall 242, the contact between the plunger 240 and the blade housing 110 may occurs first with a time difference from or may occur simultaneously with the contact between the connector 180 and the first and second arms 291 and 292, depending on the relative positions between the distal end portion 241a of the plunger 240 and the first and second end portions 291c and 292c, the lower surface shapes of the blade housing 110 to come into contact with the plunger 240, the shapes of the connector 180, etc. in the process of coupling the coupling portion 290 and the connector 180.

Because the plunger 240 is elastically supported by the elastic member 260 (see FIG. 5) disposed between the plunger 240 and the pusher 250, the plunger 240 maintains the contact with the razor cartridge 10 and provides the restoring force to the razor cartridge 10 while moving forward or backward along the first direction even though the razor cartridge 10 pivots being coupled to the razor handle 20.

Referring to FIG. 13, in the state that the handle head 22 is coupled to the razor cartridge 10, the distal end portion 291d of the first arm 291 and the distal end portion 292d of the second arm 292 may be positioned in front of the distal end portion 241a of the plunger 240 in the first direction.

Referring to FIG. 12, even when the coupling portion 290 is coupled to the connector 180, the coupling portion 290 is configured not to be exposed to the outside by the restoring force providing portion 220. For example, the first arm 291 and the second arm 292 exposed to the outside of the plunger housings 230 and 270 may be covered with the plunger 240 and not exposed to the outside. For example, when the razor cartridge 10 and the razor handle 20 are coupled, the first arm 291 and the second arm 292 may not be exposed to the outside by the plunger 240 in the state (resting position) that the razor cartridge 10 is supported by the plunger 240 without an external force applied thereto, but the first arm 291 and the second arm 292 may be at least partially not covered by the plunger 240 but exposed to the outside in the state that the razor cartridge 10 is pivoted from the resting state by an external force applied to the razor cartridge 10 and/or the razor handle 20.

At least in the resting position, in the state that the coupling portion 290 is coupled to the connector 180 so as not to be exposed to the outside by the plunger 240, an outer distance D5 between the first end portion 291c and the second end portion 292c may be smaller than or substantially equal to the longitudinal width D3 of the plunger 240.

Further, an inner distance D4 between the first end portion 291c and the second end portion 292c may be smaller than the longitudinal width D3 of the plunger 240, but the disclosure is not limited thereto. According to an embodiment, the inner distance D4 between the first end portion 291c and the second end portion 292c may be substantially equal to the longitudinal width D3 of the plunger 240. In this case, when the coupling portion 290 is coupled to the connector 180, the first arm 291 and the second arm 292 exposed to the outside of the plunger housings 230 and 270 may not be exposed to the outside as covered not only with the plunger 240 but also with a certain region of the connector 180 located at the longitudinal lateral side of the plunger 240.

For example, in the state that the coupling portion 290 is coupled to the connector 180, a ratio of the longitudinal width D3 of the plunger 240 to an outer distance D5 between the first end portion 291c and the second end portion 292c may range from 0.8 to 1.2.

Meanwhile, the inner distance D4 and the outer distance D5 between the first end portion 291c and the second end portion 292c in the state that the coupling portion 290 is coupled to the connector 180 may be substantially the same as the inner distance D1 (see FIG. 11) and the outer distance D2 between the first end portion 291c and the second end portion 292c in the state that the coupling portion 290 is detached from the connector 180.

Alternatively, the inner distance D4 and the outer distance D5 between the first end portion 291c and the second end portion 292c in the state that the coupling portion 290 is coupled to the connector 180 may be smaller than the inner distance D1 (see FIG. 11) and the outer distance D2 between the first end portion 291c and the second end portion 292c in the state that the coupling portion 290 is detached from the connector 180.

As examples shown in FIGS. 12 and 13, the restoring force providing portion 220 includes the plunger 240, but the disclosure is not limited thereto. Alternatively, the restoring force providing portion 220 may include a cantilever structure and/or a rubber member providing an elastic force, etc. to provide the restoring force to the razor cartridge 10.

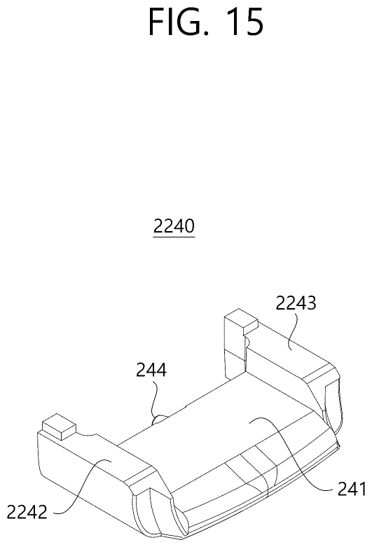

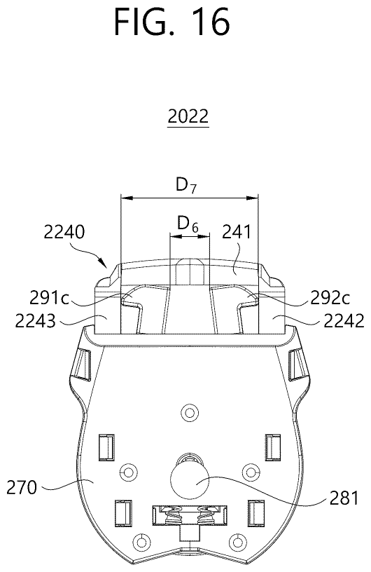

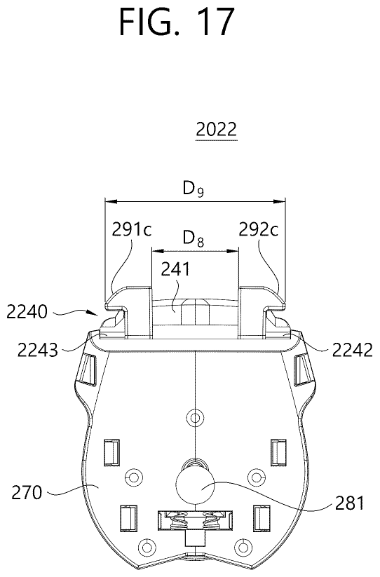

FIG. 15 is a perspective view showing a plunger 2240 according to a second embodiment of the disclosure, FIG. 16 is a bottom view showing a state that a handle head 2022 to which the plunger 2240 according to the second embodiment of the disclosure is applied is detached from a razor cartridge 10, and FIG. 17 is a bottom view showing a state that the handle head 2022 to which the plunger 2240 according to the second embodiment of the disclosure is applied is coupled to the razor cartridge 10. For the convenience of description, components similar to those of the foregoing embodiment will be assigned similar reference numerals, and repetitive descriptions to the foregoing embodiment will be omitted.

Referring to FIG. 15, the plunger 2240 according to a second embodiment of the disclosure is formed such that a first lateral wall 2243 and a second lateral wall 2242 are thicker than those of the plunger 240 according to the first embodiment. For example, the first lateral wall 2243 and the second lateral wall 2242 may be formed to have thickness larger than or substantially equal to the longitudinal width of the plunger opposite end 182 of the razor cartridge 10 or the sum of the widths of the plunger opposite end 182 and the guide surface 183. Alternatively, the distance between the first lateral wall 2243 and the second lateral wall 2242 may be formed to be smaller than or substantially equal to the distance between the pair of plunger opposite ends 182 or the distance between the pair of guide surfaces 183.

Referring to FIG. 16, when the handle head 2022 is detached from the razor cartridge 10, the first end portion 291c and the second end portion 292c of the coupling portion 290 are supported on the first lateral wall 2243 and the second lateral wall 2242, respectively. In this case, an inner distance D6 between the first end portion 291c and the second end portion 292c is smaller than the inner distance D1 (see FIG. 12) between the first end portion 291c and the second end portion 292c according to the foregoing embodiment.

When the handle head 2022 according to the second embodiment of the disclosure is coupled to the razor cartridge 10, the plunger 2240 retreats in the state of FIG. 16, and the first end portion 291c and the second end portion 292c are positioned forward of the plunger 2240 in the first direction and coupled to the connector 180 as shown in FIG. 17.

Referring to FIGS. 16 and 17, in the process of coupling the handle head 2022 according to the second embodiment of the disclosure with the razor cartridge 10, the first end portion 291c and the second end portion 292c are detached from the plunger 2240, and thus the first end portion 291c and the second end portion 292c are spread moving away from each other and coupled to the connector 180.

An inner distance D8 and an outer distance D9 between the first end portion 291c and the second end portion 292c in the state that the coupling portion 290 is coupled to the connector 180 may be larger than or substantially equal to the inner distance D6 and an outer distance D7 between the first end portion 291c and the second end portion 292c in the state that the coupling portion 290 is detached from the connector 180.

In the state that the coupling portion 290 is coupled to the connector 180, the inner distance D8 or the outer distance D9 between the first end portion 291c and the second end portion 292c may be smaller than or substantially equal to the longitudinal width of the plunger 2240.

In the case where the inner distance D6 between the first end portion 291c and the second end portion 292c is smaller than or substantially equal to the distance between the pair of guide surfaces 183 or the distance between the pair of plunger opposite ends 182, the first end portion 291c and the second end portion 292c may minimize or avoid contact with the pair of guide surfaces 183 while the handle head 2022 is coupling with the razor cartridge 10. Accordingly, a user can couple the razor cartridge 10 and the handle head 2022 more quickly with less force.

The handle head 2022 according to the second embodiment of the disclosure may also be configured such that the first arm 291 and the second arm 292 protruding out of the plunger housings 230 and 270 are covered with the plunger 2240 not to be exposed to the outside in the state that the razor cartridge 10 and the handle head 22 are detached from each other, and the first arm 291 and the second arm 292 protruding out of the plunger housings 230 and 270 are covered with the plunger 2240 or with the plunger 2240 and the connector 180 not to be exposed to the outside in the state that the razor cartridge 10 and the handle head 22 are coupled to each other.

For example, the restoring force providing portion includes the plunger 240 or 2240, but the disclosure is not limited thereto. Alternatively, the restoring force providing portion 220 may include a cantilever structure, and/or a rubber member providing an elastic force, etc., to provide a restoring force to the razor cartridge 10.

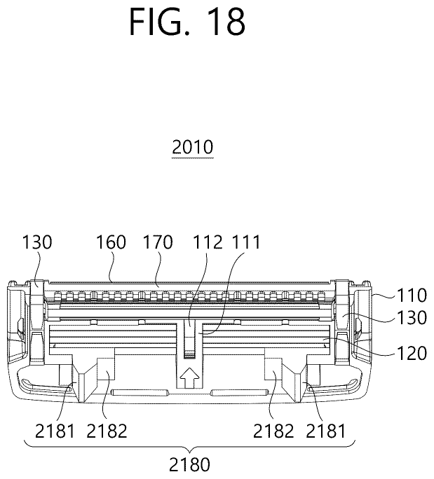

FIG. 18 is a bottom view showing an alternative example of a razor cartridge 2010 according to an embodiment of the disclosure. For the convenience of description, components similar to those of the foregoing embodiment will be assigned similar reference numerals, and repetitive descriptions to the foregoing embodiment will be omitted.

Referring to FIG. 18, the razor cartridge 2010 may include a connector 2180 with a pair of guide posts 2181 and a pair of plunger opposite ends 2182.

In the case where the razor cartridge 2010 couples with the handle head 22 or 2022, contact between the first and second end portions 291c and 292c and the pair of guide surfaces 183 is omitted in the process of coupling the handle head 22 or 2022 and the razor cartridge 2010. Therefore, a user can couple the razor cartridge 2010 and the handle head 22 or 2022 more quickly with less force.

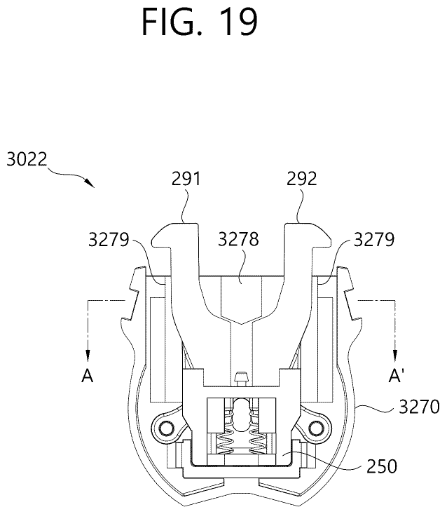

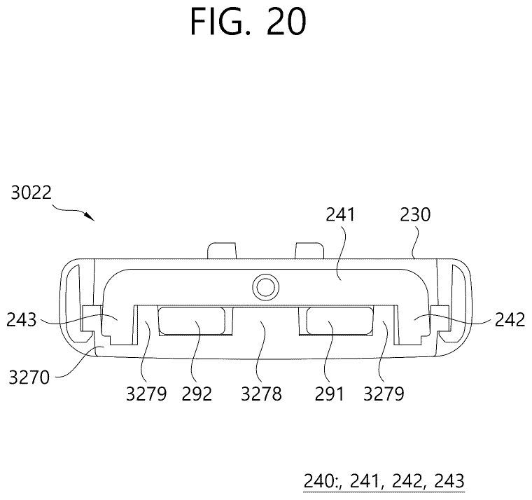

FIG. 19 is a view showing a portion of a handle head according to a third embodiment of the disclosure, and FIG. 20 is a schematic cross-sectional view of the handle head according to the third embodiment of the disclosure. FIG. 20 is a schematic cross-sectional view taken along line AA′ of FIG. 19. For the convenience of description, components similar to those of the foregoing embodiment will be assigned similar reference numerals, and repetitive descriptions to the foregoing embodiment will be omitted.

Referring to FIGS. 19 and 20, a handle head 3022 according to the third embodiment of the disclosure may further include a protrusion 3278 compared to the handle head 22 according to the first embodiment.

The protrusion 3278 may be formed to protrude from one surface of a plunger lower housing 3270 so as to be positioned between the first arm 291 and the second arm 292.

In the neutral state, the protrusion 3278 may be adjacent to and face the first arm 291 and the second arm 292, or may support the first arm 291 and the second arm 292. When the protrusion 3278 supports the first arm 291 and the second arm 292, the first arm 291 and the second arm 292 are no longer spread moving away from each other in the neutral state, thereby maintaining the positions of the first arm 291 and the second arm 292 constant in the neutral state.

Referring to FIGS. 19 and 20, the handle head 3022 according to the third embodiment of the disclosure may further include a pair of plunger guide lateral walls 3279.

Each plunger guide lateral wall 3279 may be formed to protrude from one surface of the plunger lower housing 3270 so as to be spaced inwardly apart from the outer wall of the plunger lower housing 3270.

The plunger guide lateral wall 3279 may be formed in parallel to the moving direction of the plunger 240, and guide the forward/retreat of the plunger 240 together with the outer wall of the plunger lower housing 3270.

Further, the plunger guide lateral wall 3279 may support the first arm 291 and the second arm 292 in the neutral state. In this case, the first arm 291 and the second arm 292 do not further spread moving away from each other in the neutral state, thereby maintaining the positions of the first arm 291 and the second arm 292 constant in the neutral state.

Referring to FIG. 20, the plunger upper housing 230 slidably accommodates at least a portion of the upper cover 241 of the plunger 240.

The first lateral wall 243 and the second lateral wall 242 of the plunger 240 are slidably accommodated in spaces between the outer wall of the plunger lower housing 3270 and the plunger guide lateral walls 3279, respectively.

The plunger guide lateral wall 3279, the first arm 291, the second arm 292 and the protrusion 3278 may partially support the lower portion of the upper cover 241 of the plunger 240.

The upper portion of the upper cover 241 is supported by the plunger upper housing 230, and the lower portion of the upper cover 241 is supported by the plunger guide lateral wall 3279, the first arm 291, the second arm 292, and the protrusion 3278. Additionally, the first lateral wall 243 and the second lateral wall 242 are supported on the lateral sides by the plunger guide lateral wall 3279 and the outer wall of the plunger lower housing 3270 so that the plunger 240 may stably repeat the forward/retreat without shaking in the up, down, left, and right directions.

Therefore, the plunger 240 stably and elastically supports the razor cartridge, thereby providing a stable shave and improved shave feeling.

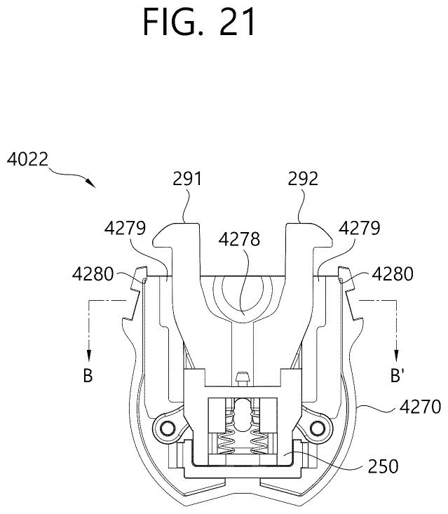

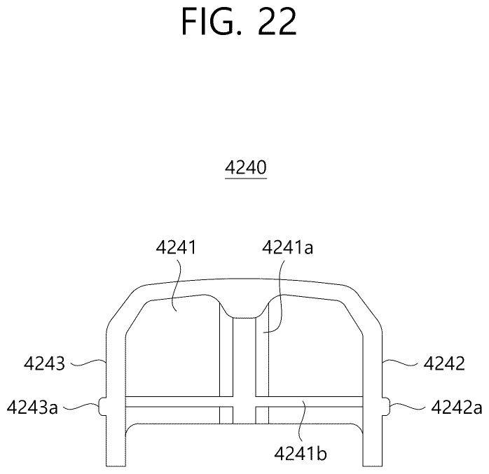

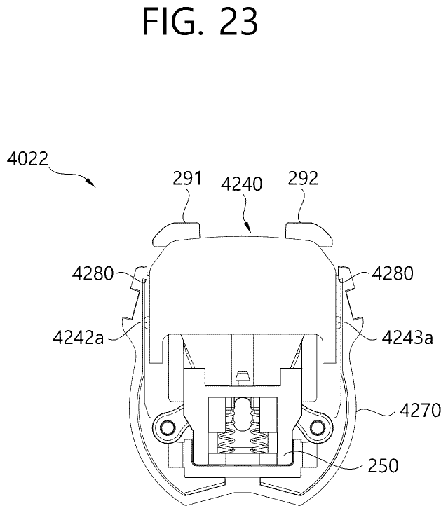

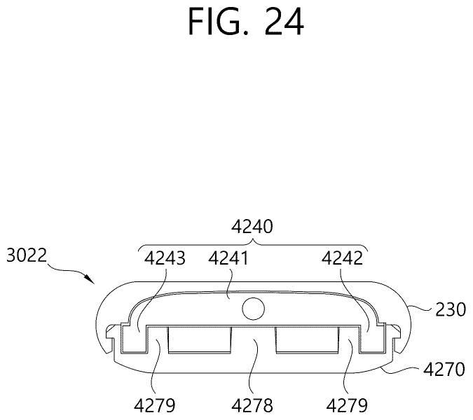

FIG. 21 is a view showing a portion of a handle head according to a fourth embodiment of the disclosure, FIG. 22 is a bottom view showing a plunger according to the fourth embodiment of the disclosure, FIG. 23 is a view showing a coupled state of a plunger lower housing and the plunger according to the fourth embodiment of the disclosure, and FIG. 24 is a schematic cross-sectional view of a handle head according to the fourth embodiment of the disclosure. FIG. 24 is a schematic cross-sectional view taken along line BB′ of FIG. 21. For the convenience of description, components similar to those of the foregoing embodiment will be assigned similar reference numerals, and repetitive descriptions to the foregoing embodiment will be omitted.

Referring to FIG. 21, a handle head 4022 according to the fourth embodiment of the disclosure may further include a protrusion 4278, compared to the handle head 22 according to the first embodiment.

Similarly to the foregoing handle head 3022 according to the third embodiment, the protrusion 4278 may be formed to protrude from one surface of a plunger lower housing 4270 so as to be positioned between the first arm 291 and the second arm 292. However, the protrusion 4278 according to this embodiment may be formed in a C-shape open toward the front through which a plunger 4240 forwards/retreats. The shapes of the protrusions 3278 and 4278 according to the third and fourth embodiments may be variously modified.

The function of the protrusion 4278 is similar to that of the foregoing protrusion 3278 according to the third embodiment, and thus repetitive descriptions thereof will be omitted.

The handle head 4022 according to the fourth embodiment of the disclosure may also further include a pair of plunger guide lateral walls 4279. The plunger guide lateral wall 4279 is similar to the foregoing plunger guide lateral wall 3279 according to the third embodiment described above, and thus repetitive description thereof will be omitted.

The handle head 4022 according to the fourth embodiment of the disclosure may further include a pair of stoppers 4280.

Each stopper 4280 may be formed to protrude from the outer wall of the plunger lower housing 4270 toward the plunger guide lateral wall 3279. The stopper 4280 may be formed to form a forward limit point of the plunger 4240 in conjunction with projections 4242a and 4243a of the plunger 4240.

Referring to FIG. 22, the plunger 4240 according to the fourth embodiment of the disclosure may include an upper cover 4241, a first lateral wall 4243 extending downwardly from a first side of the upper cover 4241, and a second lateral wall 4242 extending downwardly from a second side of the upper cover 4241.

On the lower surface of the upper cover 4241, a cover support portion 4241a may be formed to protrude downward. The cover support portion 4241a may be configured to be supported by the protrusion 4278 while the plunger 4240 forwards/retreats. For example, the cover support portion 4241a may be formed to protrude in a direction parallel to the forward/retreat direction of the plunger 4240 on the lower surface of the upper cover 4241.

Further, on the lower surface of the upper cover 4241, a cross-support portion 4241b may be formed to connect the first lateral wall 4243 and the second lateral wall 4242 across the cover support portion 4241a.

The cover support portion 4241a and the cross-support portion 4241b formed on the lower surface of the upper cover 4241 may prevent the breakage of the upper cover 4241 and the deformation of the upper cover 4241 due to an external force applied to the upper cover 4241 of the plunger 4240.

The first lateral wall 4243 may include the projection 4243a formed to protrude outwardly, and the second lateral wall 4242 may include the projection 4242a formed to protrude outwardly.

Referring to FIG. 23, the projections 4242a and 4243a may be positioned adjacent to the outer walls of the plunger lower housing 4270, respectively. When the plunger 4240 forwards a certain distance or more, the plunger 4240 supported by the stopper 4280 is blocked from forwarding and at the same time prevented from being detached. A point where the projections 4242a and 4243a and the stopper 4280 come into contact with each other may be the forward limit point of the plunger 4240.

FIGS. 22 and 23 illustrate examples in which the projections 4242a and 4243a protrude outwardly from the first lateral wall 4243 and the second lateral wall 4242, respectively. However, as an alternative embodiment, the projections 4242a and 4243a may be configured to protrude inwardly from the first lateral wall 4243 and the second lateral wall 4242, respectively. In this case, the stopper 4280 may be formed to protrude from the plunger guide lateral wall 4279 toward the outer wall of the plunger lower housing 4270.

Referring to FIG. 24, the plunger upper housing 230 slidably accommodates at least a portion of the upper cover 4241 of the plunger 4240 therein.

The cover support portion 4241a and the cross-support portion 4241b may be located above the first arm 291, the second arm 292, and the protrusion 4278.

The first lateral wall 4243 and the second lateral wall 4242 of the plunger 4240 are slidably accommodated in spaces between the plunger guide lateral walls 4279 and the outer walls of the plunger lower housing 4270, respectively.

The plunger guide lateral wall 4279, the first arm 291, the second arm 292 and the protrusion 4278 may partially support the lower portions of the cover support portion 4241a and the cross-support portion 4241b.

The upper portion of the upper cover 4241 is supported by the plunger upper housing 230, and the lower portion (the cover support portion 4241a and the cross-support portion 4241b) of the upper cover 4241 is supported by the plunger guide lateral wall 4279, the first arm 291, the second arm 292, and the protrusion 4278. Additionally, the first lateral wall 4243 and the second lateral wall 4242 are supported on the lateral sides by the plunger guide lateral wall 4279 and the outer wall of the plunger lower housing 4270 so that the plunger 4240 may stably repeat the forward/retreat without shaking in the up, down, left, and right directions.

Therefore, the plunger 4240 stably and elastically supports the razor cartridge, thereby providing a stable shave and improved shaving feeling.

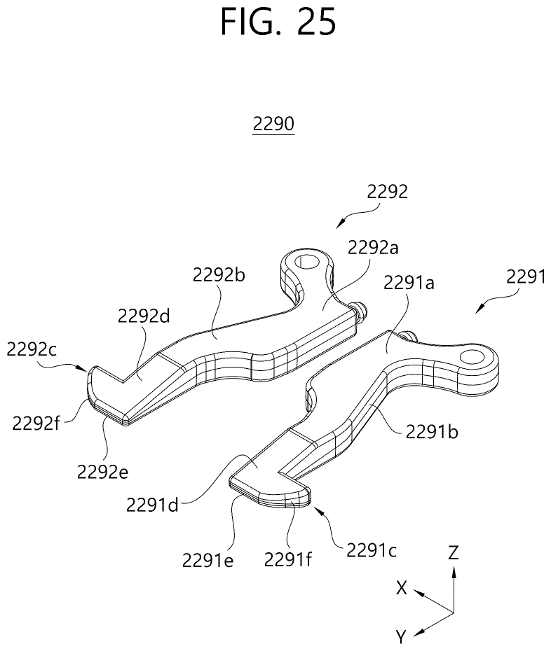

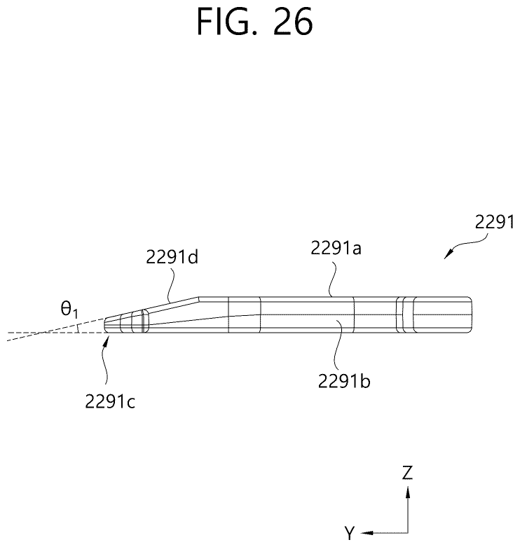

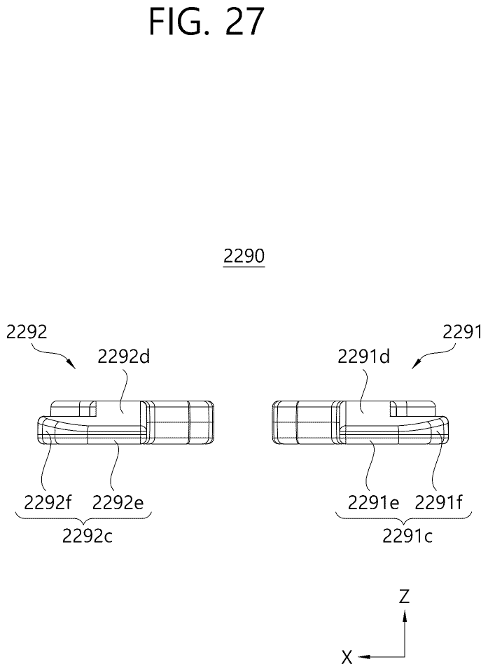

FIG. 25 is a perspective view showing a coupling portion according to a fifth embodiment of the disclosure, FIG. 26 is a lateral view showing the coupling portion according to the fifth embodiment of the disclosure, and FIG. 27 is a front view showing the coupling portion according to the fifth embodiment of the disclosure.

Referring to FIG. 25 to FIG. 27, a coupling portion 2290 according to the fifth embodiment of the disclosure includes a first arm 2291 and a second arm 2292.

The first arm 2291 may include a first driving arm 2291a, a first driving surface 2291b, and a first end surface 2291c. The first driving arm 2291a, the first driving surface 2291b, and the first end surface 2291c are similar to the first driving arm 291a, the first driving surface 291b and the first end portion 291c of the foregoing first arm 291, respectively, and thus repetitive descriptions thereof will be omitted.

Referring to FIGS. 25 to 27, the first arm 2291 according to an embodiment includes a first inclined surface 2291d formed on an upper surface of the end portion thereof. Referring to FIG. 26, the first inclined surface 2291d may form a downward slope toward the end portion of the first arm 2291. The first inclined surface 2291d may be formed to extend up to the end portion of the first arm 2291. The first inclined surface 2291d may have an inclination angle θ1 of 14 degrees to 30 degrees, preferably 15 degrees to 20 degrees.

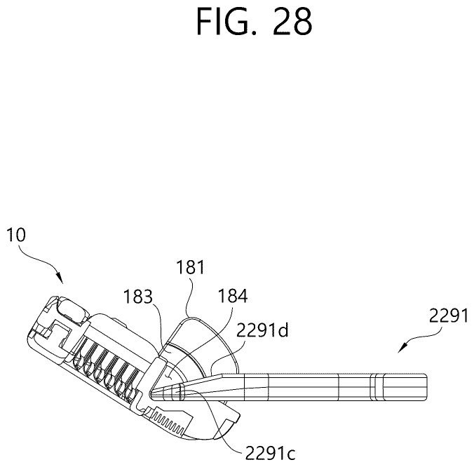

When the inclination angle θ1 of the first inclined surface 2291d is less than 14 degrees, the end portion of the first arm 2291 is so thin that sufficient rigidity and durability cannot be secured against repeated friction or collision with the connector 180. Further, when the inclination angle θ1 of the first inclined surface 2291d is greater than 30 degrees, a space occupied by the first end portion 291c within the accommodating space 184 increases (see FIG. 28), and thus the maximum pivot angle of the razor cartridge 10 may decrease.

Referring to FIG. 25, at least a portion of the upper surface of the first end surface 2291c formed to protrude in an outward direction (negative X-axis direction) of the first arm 2291 may include the first inclined surface 2291d.

Referring to FIG. 27, the first end surface 2291c includes a first region 2291e and a second region 2291f connecting the upper surface and the lower surface. The second region 2291f may extend from the first region 2291e outward in the longitudinal direction (in the negative X direction). The second region 2291f may be bent from the first region 2291e and extend outwardly and rearwardly in the longitudinal direction. The first region 2291e may form a front surface of the first end surface 2291c, and the second region 2291f may form an outer surface of the first end surface 2291c. The second region 2291f may be formed to have a height that increases outwardly in the longitudinal direction (in the negative X direction). In other words, the upper end of the second region 2291f may form an upward slope outwardly in the longitudinal direction (in the negative X direction) with respect to the upper end of the first region 2291e. This shape of the second region 2291f improves the recognition for the first end surface 2291c when a user views the front of the first end surface 2291c, and enables more secure attachment/detachment of the first end surface 2291c to the connector 180.

Referring to FIGS. 25 to 27, the second arm 2292 may include a second driving arm 2292a, a second driving surface 2292b, and a second end portion 2292c. The second driving arm 2292a, the second driving surface 2292b and the second end portion 2292c are similar to the second driving arm 292a, the second driving surface 292b and the second end portion 292c of the foregoing second arm 292, respectively, and thus repetitive descriptions thereof will be omitted.

Referring to FIGS. 25 to 27, the second arm 2292 according to an embodiment includes a second inclined surface 2292d formed on an upper surface of the end portion thereof. The second inclined surface 2292d may form a downward slope toward the end portion of the second arm 2292. The second inclined surface 2292d may be formed to extend up to the end portion of the second arm 2292. The second inclined surface 2292d may have an inclination angle θ1 of 14 degrees to 30 degrees, preferably 15 degrees to 20 degrees.

When the inclination angle θ1 of the second inclined surface 2292d is less than 14 degrees, the end portion of the second arm 2292 is so thin that sufficient rigidity and durability cannot be secured against repeated friction or collision with the connector 180. Further, when the inclination angle θ1 of the second inclined surface 2292d is greater than 30 degrees, a space occupied by the second end portion 292c within the accommodating space 184 increases (see FIG. 28), and thus the maximum pivot angle of the razor cartridge 10 may decrease.

Referring to FIG. 25, at least a portion of an upper surface of the second end portion 2292c that protrudes in an outward direction (positive X-axis direction) of the second arm 2292 may include the second inclined surface 2292d.

Referring to FIG. 27, the second end portion 2292c includes a first region 2292e and a second region 2292f connecting the upper surface and the lower surface. The second region 2292f may extend from the first region 2292e outwardly in the longitudinal direction (in the positive X direction). The second region 2292f may be bent from the first region 2292e and extend outwardly and rearwardly in the longitudinal direction. The first region 2292e may form a front surface of the second end portion 2292c, and the second region 2292f may form an outer surface of the second end portion 2292c. The second region 2292f may be formed to have a height that increases outwardly in the longitudinal direction (in the positive X direction). In other words, the upper end of the second region 2292f may form an upward slope outwardly in the longitudinal direction (in the positive X direction) with respect to the upper end of the first region 2292e. This shape of the second region 2292f improves the recognition for the second end portion 2292c when a user views the front side of the second end portion 2292c, and enables more secure attachment/detachment of the second end portion 2292c to the connector 180.

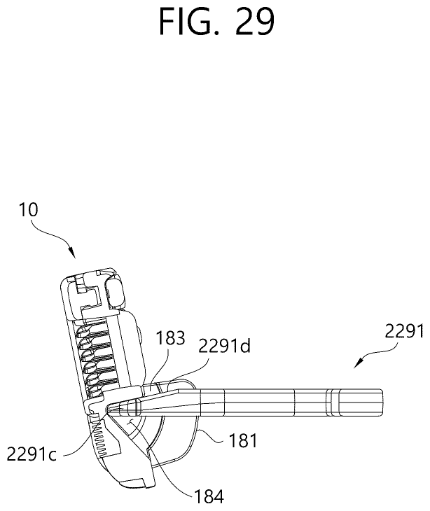

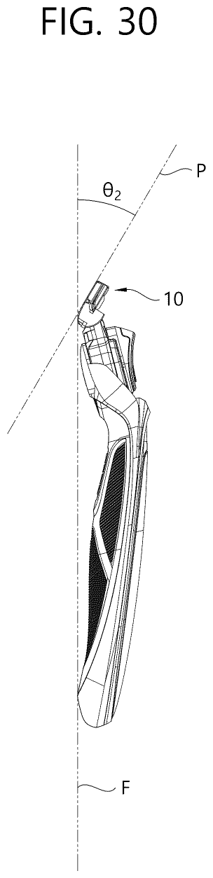

FIG. 28 is a view showing a coupled state of the coupling portion according to the fifth embodiment of the disclosure and a razor cartridge in a resting state. The resting state refers to a state in which no external force is applied to the razor cartridge 10 coupled to the razor handle 20. Further, FIG. 29 is a view showing a coupled state of the coupling portion according to the fifth embodiment of the disclosure and a razor cartridge in a maximum pivoted state, and FIG. 30 is a view showing a state in which a razor assembly according to an embodiment of the disclosure is put on a floor.

Referring to FIG. 28, the coupling portion 2290 according to the fifth embodiment of the disclosure includes the first end surface 2291c and the second end portion 2292c, which are inserted into the accommodating space 184 of the razor cartridge 10 to couple the razor handle 20 and the razor cartridge 10.

The first arm 2291 is formed with the first inclined surface 2291d that forms a downward slope toward the first end surface 2291c, and the second arm 2292 is formed with the second inclined surface 2292d that forms a downward slope toward the second end portion 2292c. Therefore, in the process of coupling the coupling portion 2290 and the connector 180, the first end surface 2291c and the second end portion 2292c may easily enter the accommodating space 184. This allows a user to couple the razor cartridge 10 and the razor handle 20 with less force.

For smooth cam action between the first and second end surfaces 2291c and 2292c and the pair of guide surfaces 183 in the process of coupling the coupling portion 2290 and the connector 180, the second region 2291f of the first end surface 2291c may have a surface which is convex outwardly in the longitudinal direction (in the negative X direction), and the second region 2292f of the second end portion 2292c may have a surface which is convex outwardly in the longitudinal direction (in the positive X direction).

Further, referring to FIGS. 28 and 29, the end portions of the first end surface 2291c and the second end portion 2292c become thinner by the first inclined surface 2291d and the second inclined surface 2292d, so that the first end surface 2291c and the second end portion 2292c can forward deeper into the accommodating space 184, thereby enabling more stable coupling between the coupling portion 2290 and the connector 180. Further, the end portions of the first end surface 2291c and the second end portion 2292c actually function as pivot axes of the razor cartridge 10, and thus the actual pivot motion of the razor cartridge 10 may be implemented very similarly to design intention.

Further, referring to FIG. 29, the first inclined surface 2291d and the second inclined surface 2292d of the razor cartridge 10 may be in contact with the inner wall of the accommodating space 184 in the maximum pivoted state. In other words, the first inclined surface 2291d and the second inclined surface 2292d are formed on the first arm 2291 and the second arm 2292, respectively, so that the maximum pivot angle of the razor cartridge 10 can be increased based on each inclination angle θ1 of the inclined surfaces 2291d and 2292d. As the maximum pivot angle of the razor cartridge 10 increases, a user can shave with minimum wrist movement even when shaving a body area with a large curve, thereby improving shaving convenience.

Because the inclination angles θ1 of the first inclined surface 2291d and the second inclined surface 2292d are related to the maximum pivot angle of the razor cartridge 10, the maximum pivot angle of the razor cartridge 10 may be controlled by adjusting the inclination angles θ1 of the first inclined surface 2291d and the second inclined surface 2292d and the shape of the accommodating space 184. For example, as the inclination angles θ1 of the first inclined surface 2291d and the second inclined surface 2292d decrease, the first end surface 2291c and the second end portion 2292c become thinner, and the spaces occupied by the first end surface 2291c and the second end portion 2292c in the accommodating space 184 decrease, thereby increasing the maximum pivot angle of the razor cartridge 10. On the other hand, as the inclination angles θ1 of the first inclined surface 2291d and the second inclined surface 2292d increase, the first end surface 2291c and the second end portion 2292c become thicker, and the spaces occupied by the first end surface 2291c and the second end portion 2292c in the accommodating space 184 increase, thereby decreasing the maximum pivot angle of the razor cartridge 10.

Further, the coupling portion 2290 according to this embodiment includes the first inclined surface 2291d and the second inclined surface 2292d formed on the upper surface of the arms 2291 and 2292, respectively, so that the razor cartridge 10 can have a smaller resting angle θ2 as shown in FIG. 30, compared to a case where the inclined surface is formed on the lower surface of each arm.

The resting angle θ2 may refer to an angle between the upper surface of the razor cartridge 10 and a floor F when the razor assembly in the resting state is put on the floor F. Alternatively, the resting angle θ2 may refer to an angle between a shaving plane P of the razor cartridge 10 and the floor F when the razor assembly in the resting state is put on the floor F. The shaving plane P may refer to a plane with which the guard 140 (see FIG. 2) and the cap 150 (see FIG. 2) of the razor cartridge 10 are in contact. Alternatively, the resting angle θ2 may refer to an angle formed between an imaginary line F connecting points where the razor cartridge 10 and the razor handle are in contact with the plane and the upper surface or shaving plane P of the razor cartridge 10 when the razor assembly in the resting state is settled on an arbitrary plane. The resting angle θ2 may be 18 degrees to 24 degrees, preferably 20 degrees to 23 degrees.

When the resting angle θ2 decreases, a retreat distance of the plunger 240 (see FIG. 5) based on the pivoting of the razor cartridge 10 in the shaving process increases, and thus a contraction distance of the elastic member 260 (see FIG. 5) increases, thereby increasing the restoring force acting on the razor cartridge 10 by the plunger 240. The increased restoring force of the razor cartridge 10 improves the close contact between the razor cartridge 10 and the skin, thereby improving the shaving performance of the razor cartridge 10.

Further, when the resting angle θ2 decreases, a pivot range of the razor cartridge 10 increases, thereby improving the shaving convenience for a user.

Further, the small resting angle θ2 makes an angle between the skin surface and the razor handle in the longitudinal direction become small during shaving, and thus there is no need to excessively bend the wrist to bring the razor cartridge 10 into close contact with a skin surface. Accordingly, a user may perform strokes more comfortably while holding the razor handle. This improves the shaving convenience when shaving an area that does not require a large pivot motion of the razor cartridge 10.

Further, the second regions 2291f and 2292f of the first end surface 2291c and the second end portion 2292c are inserted into the accommodating space 184 to substantially maintain the coupled state of the razor cartridge 10 and the razor handle 20, and cause the friction and collision with the connector 180 within the accommodating space 184 when the razor cartridge 10 pivots, and therefore rigidity and durability are required in the second regions 2291f and 2292f. According to this embodiment, the coupling portion 2290 is formed such that the second regions 2291f and 2292f of the first end surface 2291c and the second end portion 2292c have a height increasing outwardly in the longitudinal direction, thereby securing the rigidity and durability of the second regions 2291f and 2292f against repeated friction and collision with the connector 180.

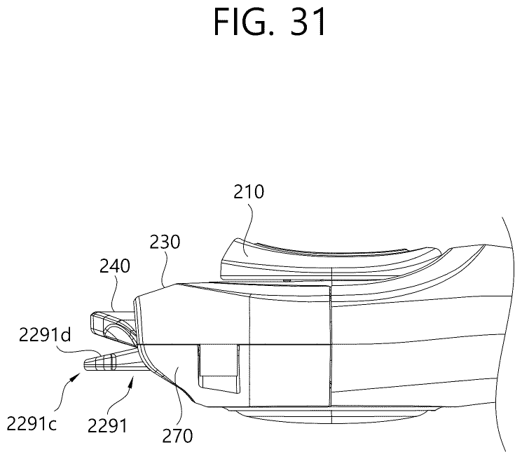

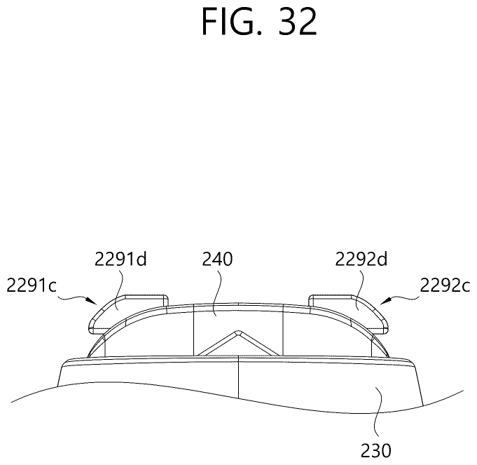

FIG. 31 is a lateral view showing a detached state of a razor handle including the coupling portion according to the fifth embodiment of the disclosure, and FIG. 32 is a plan view showing a detached state of a razor handle including the coupling portion according to the fifth embodiment of the disclosure.

Referring to FIG. 31, when the razor handle is detached from the razor cartridge, the end portions of the first arm 2291 and the second arm 2292 may be exposed to the outside through the lateral portions thereof.

The first arm 2291 and the second arm 2292 are positioned below the plunger 240. Because the first inclined surface 2291d and the second inclined surface 2292d are respectively formed on the upper surfaces of the first arm 2291 and the second arm 2292, the plunger 240 and each of the arms 2291 and 2292 can be configured to be laterally spaced apart from each other. Therefore, a user can easily recognize the arms 2291 and 2292.

Referring to FIG. 32, when the plunger 240 is viewed from above in the state that the razor handle is detached from the razor cartridge, the end portions 2291c and 2292c of the first arm 2291 and the second arm 2292 may be at least partially exposed to the outside. In other words, the end portions 2291c and 2292c of the first arm 2291 and the second arm 2292 is at least partially positioned in front of or outside the plunger 240 in the detached state so that a user can easily recognize the presence of the arms 2291 and 2292.

Accordingly, as illustrated in FIGS. 31 and 32, in the detached state, the end portions 2291c and 2292c of the first arm 2291 and the second arm 2292 are at least partially observed from at least two directions, so that a user can easily recognize the presence, position, etc. of the arms 2291 and 2292 and accurately couple the razor handle and the razor cartridge.

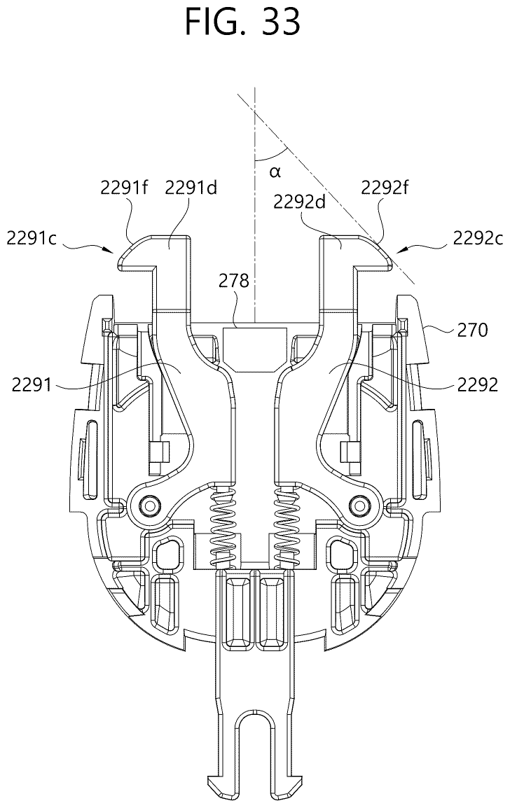

FIG. 33 is a view showing a neutral state of the coupling portion according to the fifth embodiment of the disclosure.

Referring to FIG. 33, in the neutral state, the second regions 2291f and 2292f of the arms 2291 and 2292 may be formed to extend outward and rearward from the first regions 2291e and 2292e so as to form an angle α of about 28 degrees to 45 degrees, preferably about 23 degrees to 40 degrees to the longitudinal central axis.

The foregoing shape of the second regions 2291f and 2292f allows the second regions 2291f and 2292f to smoothly slide along a pair of guide surfaces 183 (see FIG. 3) and enter the accommodating space 184 (see FIG. 4) in the process of coupling the coupling portion 2290 and the connector 180 (see FIG. 3).

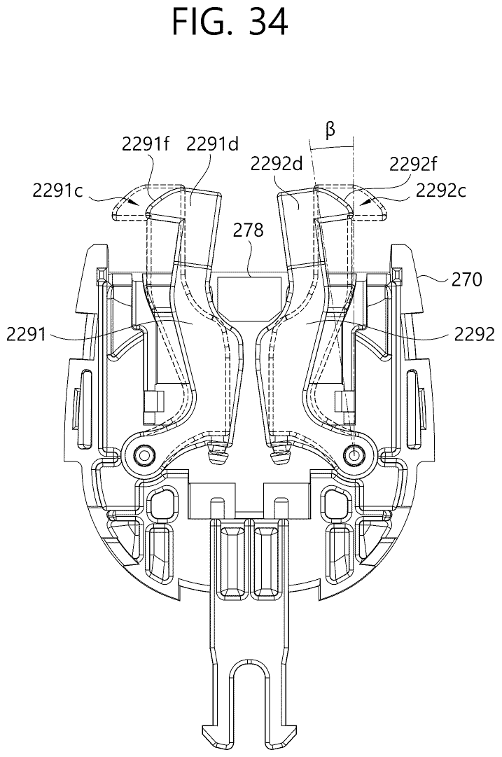

FIG. 34 is a view showing a state of a coupling process according to the fifth embodiment of the disclosure.

Referring to FIG. 34, in the process of coupling each of the arms 2291 and 2292 to the connector 180 of the razor cartridge 10, a maximum driving angle β of each of the arms 2291 and 2292 with respect to the neutral state may be approximately 6 to 11 degrees, preferably 7 to 9 degrees.

When each maximum driving angle β of the arms 2291 and 2292 exceeds the above numerical range, the razor cartridge 10 is highly likely to be detached in the shaving process.

Referring to FIGS. 33 and 34, the razor handle 20 may further include a functional provider 278 positioned between the first arm 2291 and the second arm 2292.

The functional provider 278 may be provided in the plunger housing 270, and at least partially exposed through the front of the plunger housing 270. The functional provider 278 may be located below the plunger 240, i.e., between the plunger 240 and the plunger lower housing 270, so as not to interfere with the movement of the plunger 240. The functional provider 278 may be supported by the plunger upper housing 230 (see FIG. 5) and/or the plunger lower housing 270.

The functional provider 278 may provide functions useful for shaving.

For example, the functional provider 278 may include a heat transfer element, an electrical element, and an electronic element to provide heat to the skin in the shaving process. To this end, the functional provider 278 may include a heat source, a light source, and the like, and may include circuits, wires, and the like as electrical/electronic elements for driving the heat source and/or the light source.

For example, the functional provider 278 may provide vibration and/or reciprocating driving force (linear motion, LM) to the razor cartridge 10. To this end, the functional provider 278 may include electrical/electronic elements such as a motor and an eccentric cam, mechanical elements, etc.

For example, the functional provider 278 may apply fluid (e.g., a lubricant such as shaving foam) onto the skin during the shaving process, or apply fluid for cleaning the razor cartridge 10 after shaving. To this end, the functional provider 278 may include a fluid flowing channel through which fluid is supplied, electrical/electronic elements for spraying the fluid, etc.

For example, the functional provider 278 may detect the pivoting of the razor cartridge 10. To this end, the functional provider 278 may include a sensor (for example, an optical sensor, a laser sensor, a magnetic sensor, etc.) that detects the pivoting of the razor cartridge 10, electrical/electronic elements for driving the sensor, etc.

The coupling portion 290 or 2290 according to an embodiment of the disclosures is connected to the connector 180 using two arms 291 and 292 or 2291 and 2292 spaced apart from each other, and the functional provider 278 is provided in the space between the two arms 291 and 292 or 2291 and 2292 to provide various functions useful for shaving. The functional provider 278 may be applied to all of the embodiments described above or below.

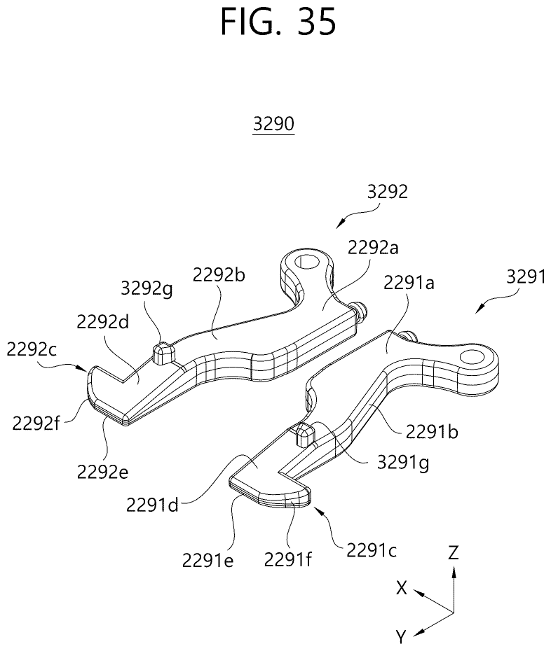

FIG. 35 is a perspective view showing a coupling portion according to a sixth embodiment of the disclosure.

Referring to FIG. 35, a coupling portion 3290 according to the sixth embodiment of the disclosure, compared to the coupling portion 2290 according to the fifth embodiment described above, further includes a first detachment preventing projection 3291g formed to protrude upward from the upper surface of a first arm 3291, and a second detachment preventing projection 3292g formed to protrude upward from the upper surface of a second arm 3292.

The first detachment preventing projection 3291g may be positioned adjacent to the rear of the first inclined surface 2291d, and the second detachment preventing projection 3292g may be positioned adjacent to the rear of the second inclined surface 2292d.

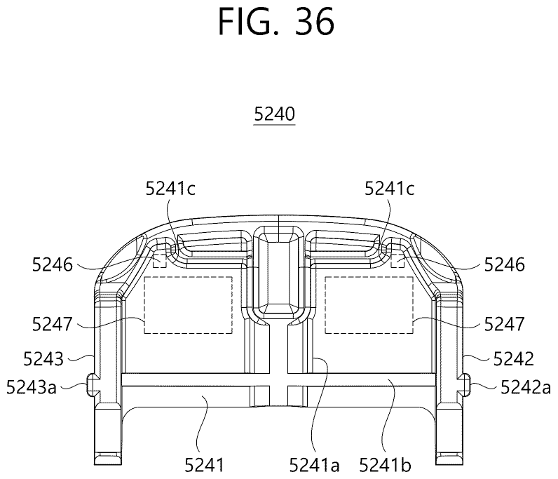

FIG. 36 is a bottom view showing a plunger portion according to the sixth embodiment of the disclosure.

Referring to FIG. 36, a plunger 5240 according to the sixth embodiment of the disclosure may include an upper cover 5241, a first lateral wall 5243 extending downwardly from a first side of the upper cover 5241, and a second lateral wall 5242 extending downwardly from a second side of the upper cover 5241.

On the lower surface of the upper cover 5241, a cover support portion 5241a and a cross-support portion 5241b may be formed.

The first lateral wall 5243 may include a projection 5243a formed to protrude outwardly, and the second lateral wall 5242 may include a projection 5242a formed to protrude outwardly.

The above configurations of the plunger 5240 according to the sixth embodiment are similar to the configurations of the foregoing plunger 4240 according to the fourth embodiment, and thus repetitive descriptions thereof will be omitted.

Referring to FIG. 36, compared to the plunger 4240 according to the fourth embodiment, the plunger 5240 according to the sixth embodiment further includes a pair of projection support portions 5241c provided on the lower surface thereof. The projection support portion 5241c may be formed on the lower surface so as to be adjacent to the distal end portion of the upper cover 5241.

The pair of projection support portions 5241c are formed to be spaced apart from the first lateral wall 5243 and the second lateral wall 5242, respectively, and first projection accommodating space 5246 may be formed between the each of the lateral walls 5243 and 5242 and each of the projection support portions 5241c. The first projection accommodating space 5246 refers to a space in which the first detachment preventing projection 3291g and the second detachment preventing projection 3292g are accommodated when the plunger 5240 retreats a certain distance or more.

The projection support portion 5241c refers to an element that interferes with the first detachment preventing projection 3291g and the second detachment preventing projection 3292g accommodated in the first projection accommodating space 5246, and may be formed to protrude or be recessed from the lower surface of the upper cover 5241.

A second projection accommodating space 5247 positioned behind the first projection accommodating space 5246 may be formed in the space between each of the lateral walls 5243 and 5242 and the cover support portion 5241a. Details of the second projection accommodating space 5247 will be described later.

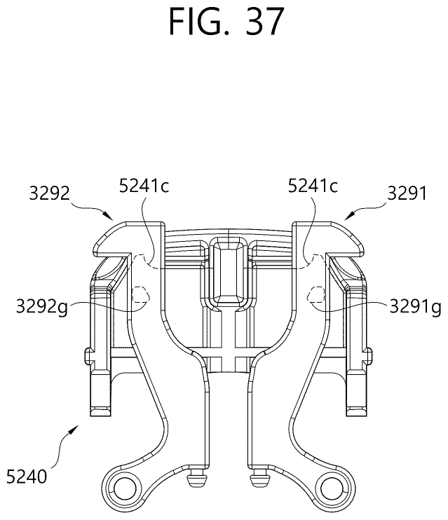

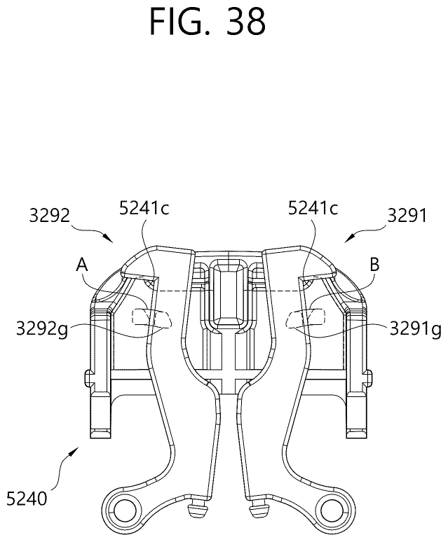

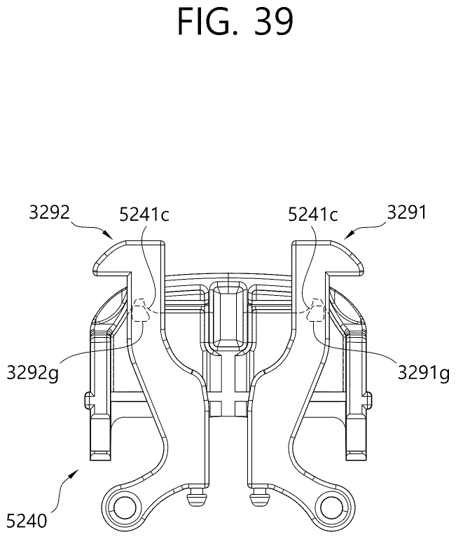

FIGS. 37 and 38 are views for describing whether the plunger according to the sixth embodiment of the disclosure in a forward state interferes with the coupling portion according to the sixth embodiment of the disclosure, and FIG. 39 is a view for describing whether the plunger according to the sixth embodiment of the disclosure in a retreat state interferes with the coupling portion according to the sixth embodiment of the disclosure.

Referring to FIGS. 36 and 37, when the plunger 5240 is in the forward state, the first detachment preventing projection 3291g and the second detachment preventing projection 3292g are each located within the second projection accommodating space 5247.

FIG. 37 shows a state of when the razor cartridge 10 and the razor handle 20 are detached, or when the razor cartridge 10 coupled to the razor handle 20 is in the resting state.

FIG. 38 illustrates a trajectory A of the first detachment preventing projection 3291g based on the rotation of the first arm 3291 up to the maximum driving angle β (see FIG. 34) and a trajectory B of the second detachment preventing projection 3292g based on the rotation of the second arm 3292 up to the maximum driving angle β, when the plunger 5240 is in the forward state.

When the plunger 5240 is in the forward state, the trajectory A of the first detachment preventing projection 3291g and the trajectory B of the second detachment preventing projection 3292g are present within the accommodating space 5247 of the second projection.

When the plunger 5240 is in the forward state, the first arm 3291 and the second arm 3292 are allowed to freely rotate up to the maximum driving angle β, so that the connector 180 and the coupling portion 3290 can be coupled/detached.

Referring to FIGS. 36 and 39, when the plunger 5240 is in the retreat state, the first detachment preventing projection 3291g and the second detachment preventing projection 3292g are each located within the first projection accommodating space 5246.

FIG. 39 shows a state in which the razor cartridge 10 coupled to the razor handle 20 is pivoted at the maximum pivot angle.

Referring to FIG. 39, when the plunger 5240 is in the retreat state, the first detachment preventing projection 3291g and the second detachment preventing projection 3292g are respectively positioned within the first projection accommodating space 5246. In this case, the projection support portion 5241c is positioned adjacent to each of the first detachment preventing projection 3291g and the second detachment preventing projection 3292g, and is positioned on the trajectory of the first detachment preventing projection 3291g based on the rotation of the first arm 3291 and the trajectory of the second detachment preventing projection 3292g based on the rotation of the second arm 3292.

Therefore, the first arm 3291 cannot rotate up to the maximum driving angle due to interference between the first detachment preventing projection 3291g and the projection support portion 5241c, and the second arm 3292 cannot rotate up to the maximum driving angle β due to interference between the second detachment preventing projection 3292g and the projection support portion 5241c.

When the razor cartridge 10 pivots up to the maximum pivot angle in the resting state, the first arm 3291 and the second arm 3292 rotate to make their end portions 2291c and 2292c be adjacent to each other.

Therefore, when one of the end portions 2291c and 2292c is rotated by more than the maximum driving angle β due to an external impact or additional external force in the state that the razor cartridge 10 has been pivoted, at least one of the end portions 2291c and 2292c may be ejected from the accommodating space 184.

However, according to this embodiment, when the plunger 5240 retreats a certain distance or more, and the first detachment preventing projection 3291g and the second detachment preventing projection 3292g are accommodated in the first projection accommodating space 5246, additional rotation of each of the arms 3291 and 3292 is prevented by the projection support portion 5241c and thus at least one of the end portions 2291c and 2292c is prevented from being ejected from the accommodating space 184, thereby preventing the razor cartridge 10 from being unintentionally ejected from the razor handle 20 during shaving.

A person having ordinary knowledge in the art to which the disclosure pertains will appreciate that the disclosure may be implemented in other specific forms without changing the technical spirit or essential features thereof. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor assembly comprising:
at least one blade formed with a cutting edge;
a blade housing accommodating the at least one blade in a longitudinal direction;
a connector disposed on one side of the blade housing;
a razor handle connected to the blade housing to enable the blade housing to pivot, the razor handle comprising a coupling portion configured to couple with the connector; and
a restoring force providing portion configured to provide a restoring force against pivoting of the blade housing, the restoring force providing portion being configured to cover at least a portion of the coupling portion from above the coupling portion.

2. The razor assembly of claim 1, wherein:
the coupling portion comprises a first arm and a second arm spaced apart from each other in a longitudinal direction,
the first arm comprises a first end portion,
the second arm comprises a second end portion, and
an inner distance between the first end portion and the second end portion is substantially equal to or smaller than a longitudinal width of the restoring force providing portion in a state that the coupling portion is coupled to the connector.

3. The razor assembly of claim 2, wherein, in a state that the coupling portion is coupled to the connector, a ratio of a longitudinal width of the restoring force providing portion to an outer distance between the first end portion and the second end portion is 0.8 to 1.2.

4. The razor assembly of claim 1, wherein the restoring force providing portion comprises:
an upper cover covering an upper portion of the coupling portion, and
lateral walls extending downwardly from opposite sides of the upper cover.

5. The razor assembly of claim 4, wherein, in a state that the coupling portion is detached from the connector, the coupling portion is supported on or in contact with the lateral wall.

6. The razor assembly of claim 5, wherein the support or contact between the coupling portion and the lateral wall is released upon coupling the coupling portion and the connector.

7. The razor assembly of claim 4, wherein, in the state that the coupling portion is detached from the connector, the coupling portion is spaced apart from the lateral wall.

8. The razor assembly of claim 1, wherein the restoring force providing portion comprises a plunger movable slidably, and a plunger housing accommodate at least a portion of the plunger.

9. The razor assembly of claim 1, wherein, in a state that the coupling portion is coupled to the connector, a distal end portion of the coupling portion is positioned further forward than a distal end portion of the restoring force providing portion in a first direction.

10. The razor assembly of claim 1, wherein, in a state that the coupling portion is detached from the connector, a distal end portion of the coupling portion is positioned further rearward than or at the same position as a distal end portion of the restoring force providing portion in a first direction.

11. The razor assembly of claim 1, wherein, in a state that the coupling portion is coupled to the connector, the coupling portion is configured not to be exposed to the outside by the restoring force providing portion.

12. The razor assembly of claim 1, wherein:
the coupling portion comprises a first arm and a second arm spaced apart from each other in a longitudinal direction,
the first arm comprises a first end portion,
the second arm comprises a second end portion, and
an inner distance between the first end portion and the second end portion in a state that the coupling portion is coupled to the connector is larger than that in a state that the coupling portion is detached from the connector.

13. The razor assembly of claim 1, wherein:
the coupling portion comprises a first arm and a second arm spaced apart from each other in a longitudinal direction,
the first arm comprises a first end portion,
the second arm comprises a second end portion, and
an inner distance between the first end portion and the second end portion in a state that the coupling portion is coupled to the connector is smaller than or substantially equal to that in a state that the coupling portion is detached from the connector.

14. The razor assembly of claim 1, wherein the blade housing is provided pivotably relative to the razor handle about a coupling position between the coupling portion and the connector.
